(19) United States
(12) Patent Application Publication
(10) Pub. No.: US 2026/0369775 A1
(43) Pub. Date: Nov. 19, 2026

(54) BATTERY APPARATUS AND ELECTRIC DEVICE

(71) Applicant: CONTEMPORARY AMPEREX TECHNOLOGY CO., LIMITED, Ningde (CN)

(72) Inventors: Jun MA, Ningde (CN); Jiangming LIU, Ningde (CN); Cancan LI, Ningde (CN)

(21) Appl. No.: 19/343,526

(22) Filed: Sep. 29, 2025

Related U.S. Application Data
(63) Continuation of application No. PCT/CN2025/104428, filed on Jun. 27, 2025.

(30) Foreign Application Priority Data
May 16, 2025 (CN) 202510637430.2

(51) Int. Cl. H01M 50/242; H01M 10/625; H01M 10/6556; H01M 50/24; H01M 50/249; H01M 50/264; H01M 50/30; H01M 50/204

(52) U.S. Cl. CPC H01M 50/242; H01M 10/625; H01M 10/6556; H01M 50/24; H01M 50/249; H01M 50/264; H01M 50/30; H01M 50/204; H01M 2200/20

(57) ABSTRACT

A battery apparatus includes a battery cell assembly including multiple battery cells arranged along a first direction and a box including first and second box bodies snap-fitted and jointly defining an accommodation space. The battery cell assembly is located in the accommodation space. The first box body includes a frame and multiple structural beams. The structural beams are located at the bottom of the frame and connected to the frame, and are spaced apart along a second direction. A side of the battery cell facing away from the second box body has an electrode terminal located between two adjacent structural beams. The battery cells are respectively connected to the structural beams and the second box body, the first direction intersects with the second direction, and a plane where the first direction and the second direction are jointly located intersects with a height direction of the box.

### CROSS-REFERENCE TO RELATED APPLICATIONS

The present application is a continuation of International Application No. PCT/CN2025/104428, filed on Jun. 27, 2025, which claims priority to Chinese Patent Application No. 202510637430.2, filed on May 16, 2025, and entitled "BATTERY APPARATUS AND ELECTRIC DEVICE", which are incorporated herein by reference in their entirety.

### TECHNICAL FIELD

The present application relates to the field of battery technologies, and specifically to a battery apparatus and an electric device.

### BACKGROUND

The connection part of a box of the existing battery apparatus and a battery cell is generally a complete plane formed by a combination of multiple plates or double-layer profile bottom plates. Before placing the battery cell, a large area of adhesive needs to be applied on the complete plane formed by the combination of multiple plates or double-layer profile bottom plates to fix the battery cell. The amount of adhesive applied is large, resulting in a higher total mass and increased cost of the battery apparatus.

### SUMMARY

In view of the above problems, the present application provides a battery apparatus and an electric device. The multiple structural beams are spaced apart at the bottom of the box, so that the weight of the box can be reduced, and the amount of adhesive applied can be saved to reduce production costs.

According to a first aspect, the present application provides a battery apparatus, including:
a battery cell assembly, including multiple battery cells arranged along a first direction; and
a box, including a first box body and a second box body, where the first box body and the second box body are snap-fitted and jointly define an accommodation space, the battery cell assembly is located in the accommodation space, the first box body includes a frame and multiple structural beams, the structural beams are located at the bottom of the frame and connected to the frame, the multiple structural beams are spaced apart along a second direction, a side of the battery cell facing away from the second box body has an electrode terminal, the electrode terminal is located between two adjacent structural beams, the battery cells are respectively connected to the structural beams and the second box body, the first direction intersects with the second direction, and a plane where the first direction and the second direction are jointly located intersects with a height direction of the box.

The multiple structural beams are spaced apart, so that a contact area between the battery cell and the first box body can be reduced to reduce an amount of structural adhesive and reduce costs. The reduction in the amount of structural adhesive can also reduce the weight of the box. Moreover, the multiple structural beams are spaced apart along the second direction, making the first box body lighter and simpler in structure compared to the traditional first box body adopting a combination of multiple plates or double-layer profile bottom plates for a large-surface structure. In addition, the battery cells are respectively connected to the structural beams and the second box body, which can improve the main frequency (natural frequency) of the battery apparatus, so as to reduce the possibility of electrical connection failure of the components inside the battery apparatus when there is vibration impact or when the battery cell swells, thereby improving the reliability of the operation of the battery apparatus.

In some embodiments, the battery cell is bonded to the second box body.

The battery cell is fixed through bonding, so that the multiple battery cells and the box form an integrated structure, which is conducive to improving the main frequency of the battery apparatus, and reducing the possibility of electrical connection failure of the components inside the battery apparatus when there is vibration impact or when the battery cell swells, thereby improving the reliability of the operation of the battery apparatus.

In some embodiments, the battery cell is bonded to the structural beam.

The battery cell is fixed through bonding, so that the multiple battery cells and the box form an integrated structure, which is conducive to improving the main frequency of the battery apparatus, and reducing the possibility of electrical connection failure of the components inside the battery apparatus when there is vibration impact or when the battery cell swells, thereby improving the reliability of the operation of the battery apparatus.

In some embodiments, the same battery cell is bonded to two adjacent structural beams.

Thus, compared to supporting the battery cell with one structural beam, the load of the structural beam can be reduced to reduce the deformation of the structural beam, and reduce the possibility of electrical connection failure of the components inside the battery apparatus when there is vibration impact or when the battery cell swells, thereby improving the reliability of the operation of the battery apparatus.

In some embodiments, the side of the battery cell facing away from the second box body is provided with a pressure relief mechanism, where the pressure relief mechanism is configured to actuate when the battery cell experiences thermal runaway and an internal pressure of the battery cell reaches a set value to release emissions, and the pressure relief mechanism is provided between two adjacent structural beams.

The pressure relief mechanism is located between two adjacent structural beams, providing a direct discharge channel for high-pressure gas and emissions during thermal runaway, facilitating the diffusion of high-temperature emissions between two adjacent structural beams. Compared to the traditional closed bottom plate design, placing the pressure relief mechanism between two adjacent structural beams can reduce the obstruction of the emissions by the bottom of the box, concentrating a pressure relief direction, effectively reducing the risk of internal pressure accumulation, and improving the safety of the battery apparatus.

In some embodiments, the electrode terminal is spaced apart from the structural beams along the second direction.

The electrode terminal and the structural beam are spaced apart, an independent arrangement space can be provided for the electrode terminal in the second direction, reducing the interference and short circuit caused by direct contact with the structural beam, providing an installation space for the connection of a busbar and the electrode terminal during assembly, and reducing the assembly difficulty. In addition, during the operation of the battery apparatus, the heat generated by the electrode terminal is large, and the electrode terminal and the structural beam are spaced apart along the second direction, which can form a natural heat dissipation space, reducing heat accumulation and improving the overall heat dissipation.

In some embodiments, the electrode terminal on the side of the battery cell facing away from the second box body includes a positive electrode terminal and a negative electrode terminal.

Thus, the electrode terminal can be set on one side or two sides of the battery cell along the height direction of the box according to different usage requirements.

In some embodiments, the electrode terminal on the side of the battery cell facing away from the second box body includes the positive electrode terminal and the negative electrode terminal. In two adjacent structural beams, along the second direction, the distance from the two adjacent structural beams to the same electrode terminal is different, and the structural beam closest to the electrode terminal is a first structural beam, along the height direction of the box, a dimension of an orthographic projection of the first structural beam on the battery cell in the second direction is S1, and the spacing between the electrode terminal and the first structural beam along the second direction is S2, where
when the structural beam is a solid beam, the ratio of S1/S2 ranges from 0.25 to 87.5; or
when the structural beam is a hollow beam, the ratio of S1/S2 ranges from 0.65 to 87.5.

Limiting the ratio of S1/S2 within the above numerical range allows, on one hand, when the structural beam is a metal beam, for a certain safe distance between the electrode terminal and the structural beam to reduce the possibility of short circuit, and facilitate the installation of electrical connection components such as the electrode terminal and the busbar. On the other hand, this ensures that the structural beam has a certain strength to resist deformation, so as to reduce the occurrence of bending deformation of the structural beam. This reduces the possibility of electrical connection failure of the components inside the battery apparatus when there is vibration impact or when the battery cell swells, thereby improving the reliability of the operation of the battery apparatus.

In some embodiments, when the structural beam is a solid beam, the ratio of S1/S2 ranges from 0.4 to 87.5; and when the structural beam is a hollow beam, the ratio of S1/S2 ranges from 0.65 to 87.5.

Thus, on one hand, the safe distance between the electrode terminal and the structural beam can be further improved to reduce the possibility of short circuit, and facilitate the installation of electrical connection components such as the electrode terminal and the busbar. On the other hand, this ensures that the structural beam has a certain strength to resist deformation, so as to reduce the occurrence of bending deformation of the structural beam. This reduces the possibility of electrical connection failure of the components inside the battery apparatus when there is vibration impact or when the battery cell swells, thereby improving the reliability of the operation of the battery apparatus.

In some embodiments, when the structural beam is a solid beam, a value of S2 ranges from 8 mm to 775 mm; and when the structural beam is a hollow beam, a value of S2 ranges from 8 mm to 575 mm.

Under the premise of taking into account the support strength of the structural beam and the insulation distance of the electrode terminal, limiting the value of S2 within the above range can meet the needs of different sizes of battery cells along the second direction, so as to select appropriate values for different sizes of battery cells.

In some embodiments, the interior of the structural beam has a heat exchange flow channel, and an inlet and an outlet respectively communicating with the heat exchange flow channel, where the heat exchange flow channel extends in the first direction.

The heat generation near the pole of the battery cell is large, and the temperature of the battery cell can be effectively controlled by cooling the region near the pole of the battery cell. In addition, the heat exchange flow channel is provided in the structural beam, which can reduce the manufacturing difficulty compared to the traditional battery apparatus using a water cooling plate.

In some embodiments, the frame includes two first side beams spaced apart along the second direction, and along the second direction, the two outermost structural beams are connected to the two first side beams in one-to-one correspondence.

The first side beam serves as the lateral boundary support of the frame, which can increase the overall rigidity of the first box body, reduce the risk of local deformation caused by uneven force, and reduce the possibility of electrical connection failure of the components inside the battery apparatus when there is vibration impact or when the battery cell swells, thereby improving the reliability of the operation of the battery apparatus.

In some embodiments, in the second direction, a reinforcing rib is connected between the outermost structural beam and the first side beam, and the reinforcing rib extends in the first direction.

Thus, the connection strength between the outermost structural beam along the second direction and the first side beam is further improved to improve the overall rigidity of the first box body, reduce the risk of local deformation caused by uneven force, and reduce the possibility of electrical connection failure of the components inside the battery apparatus when there is vibration impact or when the battery cell swells, thereby improving the reliability of the operation of the battery apparatus.

In some embodiments, the first box body also includes a spacer beam, a length direction of the spacer beam is the same as the second direction, and battery cell assemblies are respectively provided on two sides of the spacer beam along the first direction; and
the spacer beam is connected to at least some of the structural beams, and/or, the spacer beam is connected to the frame.

The arrangement of the spacer beam can further improve the bending strength of multiple structural beams to improve the main frequency of the battery apparatus, so as to reduce the possibility of electrical connection failure of the components inside the battery apparatus when there is vibration impact or when the battery cell swells, thereby improving the reliability of the operation of the battery apparatus.

In some embodiments, the first box body also includes a protective plate, where the protective plate is located on a side of the first box body facing away from the second box body and is connected to the first box body.

The arrangement of the protective plate can protect the side of the first box body facing away from the second box body, especially when the battery apparatus is applied in new energy vehicles, external impacts and collisions can be absorbed.

In some embodiments, the first box body also includes a buffer member, and the buffer member is provided between the protective plate and the structural beam.

The buffer member is provided between the protective plate and the first box body, so that external impacts can be buffered to improve the protection of the battery cell, thereby improving the reliability of the operation of the battery cell.

In some embodiments, the first box body also includes a sealing member, where the sealing member is arranged around the accommodation space, and the sealing member is provided between the protective plate and the first box body.

The sealing member can prevent external dust, water, and the like from entering the battery apparatus to protect the components inside the battery apparatus.

In some embodiments, the structural beam is a flat beam, and a thickness direction of the structural beam is the same as the height direction of the box.

Thus, this can reduce the excessive occupation of the size of the box in the height direction by the structural beam, so as to reduce the occupied space of the box, which is especially suitable for scenes where the space in the height direction of the box is limited.

In some embodiments, the first box body is located below the second box body. The battery cell is respectively connected to both the structural beam and the second box body, and the electrode terminal of the battery cells is inverted in the box. Compared to the structure where the electrode terminal is upright in the box, the space utilization of the box can be improved.

In some embodiments, the frame includes two second side beams spaced apart along the first direction, the structural beam is connected to the second side beams, the second side beams are configured to connect to a vehicle, and the first direction is configured to intersect with a traveling direction of the vehicle.

The second side beam is configured to connect to the vehicle, and the second side beam is used as a mounting beam. Since the mounting beam has the characteristics of high strength and impact resistance, the swelling force of the battery cell along the first direction can be resisted to reduce the deformation of the frame. Compared to a structure where the arrangement direction of multiple battery cells in the same battery cell assembly is the same as the traveling direction of the vehicle, the deformation of the frame can be reduced without increasing the weight and strength of the side beam of the frame along the first direction, which is conducive to reducing the weight of the first box body.

According to a second aspect, the present application provides an electric device, including the battery apparatus of the first aspect, where the battery apparatus is configured to provide electric energy to the electric device.

Since the electric device includes all the technical features of the battery apparatus of the first aspect, the effects are the same as above. Details are not described herein again.

The foregoing descriptions are merely an overview of the technical solutions of the present application. For a better understanding of the technical means in the present application such that they can be implemented according to the content of the specification, and to make the above and other objectives, features and advantages of the present application more obvious and easier to understand, the following describes specific embodiments of the present application.

### BRIEF DESCRIPTION OF THE DRAWINGS

Persons of ordinary skill in the art can clearly understand various other advantages and benefits by reading the detailed description of the embodiments below. The accompanying drawings are merely intended to illustrate some embodiments and are not intended to limit the present application. In addition, in all the accompanying drawings, the same reference signs represent the same components. In the accompanying drawings:

FIG. 1 is an exploded view of a battery apparatus according to some embodiments of the present application;

FIG. 2 is a top view of a battery apparatus according to some embodiments of the present application;

FIGS. 3, FIG. 5, and FIG. 7 and are cross-sectional views along A-A of different embodiments of the battery apparatus in FIG. 2;

FIG. 4 is a locally enlarged view of location B in FIG. 3;

FIG. 6 is a locally enlarged view of location C in FIG. 5;

FIG. 8 is a locally enlarged view of location D in FIG. 7;

FIG. 9 is an exploded view of a battery apparatus according to some embodiments of the present application;

FIG. 10 is an axonometric view of a first box body in the battery apparatus in FIG. 9;

FIG. 11 is an axonometric view of a battery cell according to some embodiments of the present application;

FIG. 12 is a partial structural diagram of a battery cell according to some embodiments of the present application;

FIG. 13 is a structural diagram of one embodiment of a first box body in a battery cell according to some embodiments of the present application;

FIG. 14 is a structural diagram of one embodiment of a first box body in a battery apparatus according to some embodiments of the present application;

FIG. 15 is a cross-sectional view along E-E in FIG. 14;

FIG. 16 is a locally exploded view of Embodiment 1 of a first box body in a battery apparatus according to some embodiments of the present application;

FIG. 17 is a cross-sectional view along F-F in FIG. 14;

FIG. 18 is a locally exploded view of Embodiment 2 of a first box body in a battery apparatus according to some embodiments of the present application;

FIGS. 19 - FIG. 21 are structural diagrams of different embodiments of a first box body in a battery apparatus according to some embodiments of the present application, and arrows in the figures are the flow directions of a heat exchange flow path;

FIG. 22 is a structural diagram of Embodiment 3 of a first box body in a battery apparatus according to some embodiments of the present application;

FIG. 23 is a cross-sectional view along G-G in FIG. 22; and

FIG. 24 is a structural diagram of an electric device being a vehicle according to some embodiments of the present application.

### REFERENCE SIGNS IN SPECIFIC EMBODIMENTS ARE DESCRIBED AS FOLLOWS

1000. vehicle; 100. battery apparatus; 200. controller; 300. motor;
110. battery cell assembly; 120. box; 121. first box body; 1211. frame; 12111. first side beam; 121111. first abutting surface; 12112. second side beam; 121121. mounting hole; 1212. structural beam; 12124. first interface; 12125. second interface; 12121. heat exchange flow channel; 1213. spacer beam; 1214. protective plate; 1215. buffer member; 1216. sealing member; 1217. reinforcing rib; 1218. current collector member; 12181. current collector unit; 121811. inserting portion; 121812. main body portion; 121813. tube portion; 1218121. current flow channel; 1218122. support rib; 12182. connection portion; 121821. protrusion; 1219. connection pipe; 122. second box body; 1221. protruding portion;
111. battery cell; 1111. pressure relief mechanism; 1112. electrode terminal; and X. first direction; Y. second direction; and Z. height direction.

### DESCRIPTION OF EMBODIMENTS

The following describes in detail some embodiments of technical solutions of the present application with reference to the accompanying drawings. The following embodiments are merely intended for a clearer description of the technical solutions of the present application and therefore are merely used as examples which do not constitute any limitation on the protection scope of the present application.

Unless otherwise defined, all technical and scientific terms used herein shall have the same meanings as commonly understood by persons skilled in the art to which the present application relates. The terms used herein are intended to merely describe the specific embodiments rather than to limit the present application. The terms "include", "comprise", and "have" and any other variations thereof in the specification, claims and brief description of drawings of the present application are intended to cover non-exclusive inclusions.

In the description of some embodiments of the present application, the technical terms "first", "second", and the like are merely intended to distinguish between different objects, and shall not be understood as any indication or implication of relative importance or any implicit indication of the number, sequence or primary-secondary relationship of the technical features indicated. In the description of some embodiments of the present application, "multiple" means at least two unless otherwise specifically defined.

In this specification, reference to "embodiment" means that specific features, structures, or characteristics described with reference to some embodiments may be included in at least one embodiment of the present application. The word "embodiment" appearing in various places in the specification does not necessarily refer to the same embodiment or an independent or alternative embodiment that is exclusive of other embodiments. It is explicitly or implicitly understood by persons skilled in the art some embodiments described herein may be combined with other embodiments.

In the description of some embodiments of the present application, the term "and/or" is only an associative relationship for describing associated objects, indicating that three relationships may be present. For example, A and/or B may indicate the following three cases: presence of only A, presence of both A and B, and presence of only B. In addition, the character "/" in this specification generally indicates an "or" relationship between contextually associated objects. In this disclosure, unless otherwise specified, phrases like “at least one of A, B, and C” and “at least one of A, B, or C” both mean only A, only B, only C, or any combination of A, B, and C.

In the descriptions of some embodiments of the present application, the term "multiple" means more than two (inclusive). Similarly, "multiple groups" means more than two (inclusive) groups, and "multiple pieces" means more than two (inclusive) pieces.

In the description of some embodiments of the present application, the orientations or positional relationships indicated by the technical terms "center", "longitudinal" "transverse", "length", "width", "thickness", "upper", "lower", "front", "rear", "left", "right", "vertical", "horizontal", "top", "bottom", "inside", "outside", "clockwise", "counterclockwise", "axial", "radial", "circumferential", and the like are based on the orientations or positional relationships as shown in the accompanying drawings. These terms are merely for ease and brevity of the description of some embodiments of the present application rather than indicating or implying that the means or components mentioned must have specific orientations, or must be constructed or manipulated according to specific orientations, and therefore shall not be construed as any limitations on embodiments of the present application.

In the descriptions of some embodiments of the present application, unless otherwise specified and defined explicitly, the technical terms "mount", "connect", "join", and "fix" should be understood in their general senses. For example, they may refer to a fixed connection, a detachable connection, or an integral connection, may refer to a mechanical connection or an electrical connection, and may refer to a direct connection, an indirect connection via an intermediate medium, an internal communication between two elements, or an interaction between two elements. Persons of ordinary skill in the art can understand specific meanings of these terms in the present application as appropriate to specific situations.

The connection part of a box of the existing battery apparatus and a battery cell is generally a complete plane formed by a combination of multiple plates or double-layer profile bottom plates, such as multiple plates or double-layer profile bottom plates combined to form a water cooling plate. Before placing the battery cell, a large area of adhesive needs to be applied on the complete plane formed by the combination of multiple plates or double-layer profile bottom plates to fix the battery cell. The amount of adhesive applied is large, resulting in a higher total mass and increased cost of the battery apparatus.

In view of this, the present application provides a battery apparatus. The multiple structural beams are spaced apart, so that a contact area between the battery cell and the first box body can be reduced to reduce an amount of structural adhesive and reduce costs. The reduction in the amount of structural adhesive can also reduce the weight of the box. Moreover, the multiple structural beams are spaced apart along the second direction, making the first box body lighter and simpler in structure compared to the traditional first box body adopting a combination of multiple plates or double-layer profile bottom plates for a large-surface structure. In addition, the battery cells are respectively connected to the structural beams and the second box body, which can improve the main frequency (natural frequency) of the battery apparatus, so as to reduce the possibility of electrical connection failure of the components inside the battery apparatus when there is vibration impact or when the battery cell swells, thereby improving the reliability of the operation of the battery apparatus.

The battery apparatus (Battery Apparatus) mentioned in some embodiments of the present application may include one or more battery cell assemblies for providing voltage and capacity. The battery cell assembly (Battery Cell Assembly) may include multiple battery cells, and the multiple battery cells are connected in series, parallel or series-parallel through a busbar.

In some embodiments, the battery cell assembly (Battery Cell Assembly) is generally formed by arranging multiple battery cells.

As an example, the battery cell assembly may be a battery module (Battery Module), and the battery module is formed by arranging and fixing multiple battery cells to form an independent module. As an example, the battery module may be formed by bundling multiple battery cells through cable ties.

In some embodiments, the battery apparatus may be a battery pack (Battery Pack), and the battery pack includes a box and one or more battery cell assemblies, where the battery cell assemblies are accommodated in the box.

As an example, the battery cell assembly may be a battery module, and the battery cell assembly can be accommodated in the box by fixing the battery module in the box.

As an example, the battery cell assembly can also be accommodated in the box by directly fixing multiple battery cells to the box.

As an example, the box may include a first box body and a second box body. The first box body and the second box body are snap-fitted to accommodate the battery cell assembly.

As an example, the box may include a top cover, a frame and a bottom plate. The top cover and the bottom plate are respectively connected to the frame, so that an enclosed space is formed inside the box to accommodate the battery cell assembly.

In some embodiments, the box may be used as part of the chassis structure of a vehicle. For example, part of the box may become at least part of a chassis of the vehicle, or part of the box may become at least part of a cross beam and longitudinal beam of the vehicle.

The technical solutions described in some embodiments of the present application are all applicable to various electric devices using battery apparatuses, for example, electric bicycles, vehicles, ships and spacecrafts. For example, the spacecrafts include airplanes, rockets, space shuttles, spaceships, and the like.

In some embodiments, the battery cell may be a secondary battery, and the secondary battery refers to a battery cell whose active material can be activated for continuous use through charging after the battery cell is discharged.

The battery cell can be a lithium-ion battery, a sodium-ion battery, a sodium-lithium-ion battery, a lithium metal battery, a sodium metal battery, a lithium-sulfur battery, a magnesium-ion battery, a nickel-hydrogen battery, a nickel-cadmium battery, and a lead storage battery. This is not limited in some embodiments of the present application.

The battery cell generally includes an electrode assembly. The electrode assembly includes a positive electrode, a negative electrode, and a separator, and the separator is provided between the negative electrode and the positive electrode. During charge and discharge process of the battery cell, active ions such as lithium ions are intercalated and deintercalated between the positive electrode and the negative electrode. The separator is provided between the positive electrode and the negative electrode to prevent short circuit of the positive electrode and negative electrode and to allow the active ions to pass through.

In some embodiments, the positive electrode may be a positive electrode plate, and the positive electrode plate may include a positive electrode current collector and a positive electrode active material provided on at least one surface of the positive electrode current collector.

As an example, the positive electrode current collector has two back-to-back surfaces in a thickness direction of the positive electrode current collector, and the positive electrode active material is provided on either or both of the two back-to-back surfaces of the positive electrode current collector.

As an example, the positive electrode current collector may be a metal foil, a conductive polymer material, a carbon material, or a composite current collector. For example, as a metal foil, pure metal, alloy, surface-treated metal may be adopted, including but not limited to, stainless steel, copper, aluminum, nickel, titanium, or silver. The composite current collector may include a polymer material fiber layer and a metal layer. The composite current collector may be formed by forming a metal material such as aluminum, aluminum alloy, nickel, nickel alloy, titanium, titanium alloy, silver, silver alloy, or the like on a polymer material matrix, for example, matrices of polypropylene, polyethylene terephthalate, polybutylene terephthalate, polystyrene, and polyethylene.

As an example, the positive electrode active material may include at least one of the following materials: lithium-containing phosphate, lithium transition metal oxide, and respective modified compounds thereof. However, the present application is not limited to these materials, and may alternatively use other conventional materials that can be used as positive electrode active materials for batteries. One type of these positive electrode active materials may be used alone, or two or more types may be used in combination. Examples of lithium-containing phosphate may include but are not limited to at least one of lithium iron phosphate (for example, LiFePO₄, or LFP for short), a composite material of lithium iron phosphate and carbon, lithium manganese phosphate (for example, LiMnPO₄), a composite material of lithium manganese phosphate and carbon, lithium manganese iron phosphate, and a composite material of lithium manganese iron phosphate and carbon. Examples of lithium transition metal oxide may include but are not limited to at least one of lithium cobalt oxide (for example, LiCoO₂), lithium nickel oxide (for example, LiNiO₂), lithium manganese oxide (for example, LiMnO₂ and LiMn₂O₄), lithium nickel cobalt oxide, lithium manganese cobalt oxide, lithium nickel manganese oxide, lithium nickel cobalt manganese oxide (for example, LiNi_{1/3}Co_{1/3}Mn_{1/3}O₂, NCM₃₃₃ for short; LiNi_{0.5}Co_{0.2}Mn_{0.3}O₂, NCM₅₂₃ for short; LiNi_{0.5}Co_{0.25}Mn_{0.25}O₂, NCM₂₁₁ for short; LiNi_{0.6}Co_{0.2}Mn_{0.2}O₂, NCM₆₂₂ for short; and LiNi_{0.8}Co_{0.1}Mn_{0.1}O₂, NCM₈₁₁ for short), lithium nickel cobalt aluminum oxide (for example, LiNi_{0.8}Co_{0.15}Al_{0.05}O₂), and modified compounds thereof. The modified compound refers to the substance obtained by modification means such as doping or coating on the basis of the above substances.

In some embodiments, the positive electrode may adopt foam metal. The foam metal may be foam nickel, foam copper, foam aluminum, foam alloy, or foam carbon. When the foam metal is used as the positive electrode, the surface of the foam metal may not be provided with a positive electrode active material. Certainly, a positive electrode active material may also be provided. As an example, the positive electrode active material is filled and/or deposited in the foam metal.

In some embodiments, the negative electrode may be a negative electrode plate, and the negative electrode plate may include a negative electrode current collector.

As an example, the negative electrode current collector may be a metal foil, a conductive polymer material, a carbon material, or a composite current collector. For example, as a metal foil, pure metal, alloy, surface-treated metal may be adopted, including but not limited to, stainless steel, copper, aluminum, nickel, titanium, or silver. The composite current collector may include a polymer material fiber layer and a metal layer. The composite current collector may be formed by forming a metal material (copper, copper alloy, nickel, nickel alloy, titanium, titanium alloy, silver, silver alloy, or the like) on a polymer material matrix (for example, matrices of polypropylene, polyethylene terephthalate, polybutylene terephthalate, polystyrene, and polyethylene).

As an example, the negative electrode plate may include a negative electrode current collector and a negative electrode active material provided on at least one surface of the negative electrode current collector.

As an example, the negative electrode current collector has two back-to-back surfaces in a thickness direction of the negative electrode current collector, and the negative electrode active material is provided on either or both of the two back-to-back surfaces of the negative electrode current collector.

As an example, the negative electrode active material may be a negative electrode active material for battery cells well-known in the art. As an example, the negative electrode active material may include at least one of the following materials: artificial graphite, natural graphite, soft carbon, hard carbon, silicon-based material, tin-based material, and lithium titanate. The silicon-based material may be selected from at least one of elemental silicon, silicon-oxygen compounds, silicon-carbon composites, silicon-nitrogen composites, or silicon alloys. The tin-based material may be selected from at least one of elemental tin, tin-oxygen compounds, or tin alloys. However, the present application is not limited to these materials, and may alternatively use other conventional materials that can be used as negative electrode active materials for battery cells. One type of these negative electrode active materials may be used alone, or two or more types may be used in combination.

In some embodiments, the negative electrode may adopt foam metal. The foam metal may be foam nickel, foam copper, foam aluminum, foam alloy, or foam carbon. When the foam metal is used as the negative electrode plate, the surface of the foam metal may not be provided with a negative electrode active material. Certainly, a negative electrode active material can also be provided.

As an example, the negative electrode active material can be filled and/or deposited in the negative electrode current collector.

In some embodiments, the material of the positive electrode current collector may be aluminum, and the material of the negative electrode current collector may be copper.

In some embodiments, the electrode assembly also includes a separator, and the separator is provided between the positive electrode and the negative electrode.

In some embodiments, the separator is an isolating film. The isolating film is not limited to any particular type in the present application, and may be any well-known porous isolating film with good chemical stability and mechanical stability.

As an example, the main material of the isolating film may be selected from at least one of glass fiber, non-woven fabric, polyethylene, polypropylene, polyvinylidene fluoride, or ceramic. The isolating film may be a single-layer film or a multi-layer composite film, which is not particularly limited. When the separator is a multi-layer composite film, all layers may be made of the same or different materials, which is not particularly limited. The isolating film may be an independent component located between the positive electrode and the negative electrode, or may be attached to surfaces of the positive electrode and the negative electrode. The surface of the isolating film may also be coated with inorganic particle coating, organic particle coating, or organic/inorganic composite coating.

In some embodiments, the separator is a solid electrolyte. The solid electrolyte is provided between the positive electrode and the negative electrode, and transports ions and isolates the positive electrode and negative electrode.

In some embodiments, the battery cell also includes an electrolyte, and the electrolyte conducts ions between the positive electrode and the negative electrode. The electrolyte is not specifically limited in this application, and may be selected as required. The electrolyte may be in a liquid state, a gel state, or a solid state.

Where a liquid electrolyte includes an electrolytic salt and a solvent.

In some embodiments, the electrolytic salt may be at least one selected from lithium hexafluorophosphate, lithium tetrafluoroborate, lithium perchlorate, lithium hexafluoroarsenate, lithium bis(fluorosulfonyl)imide, lithium bis-trifluoromethanesulfonimide, lithium trifluoromethanesulfonate, lithium difluorophosphate, lithium difluoroxalate borate, lithium bisoxalatoborate, lithium difluorobisoxalate phosphate, and lithium tetrafluoro oxalate phosphate.

In some embodiments, the solvent may be at least one selected from ethylene carbonate, propylene carbonate, ethyl methyl carbonate, diethyl carbonate, dimethyl carbonate, dipropyl carbonate, methyl propyl carbonate, ethyl propyl carbonate, butylene carbonate, fluoroethylene carbonate, methyl formate, methyl acetate, ethyl acetate, propyl acetate, methyl propionate, ethyl propionate, propyl propionate, methyl butyrate, ethyl butyrate, 1,4-butyrolactone, sulfolane, dimethyl sulfone, methyl ethyl sulfone, and diethyl sulfone. The solvent may also be selected from ether solvents. The ether solvents may include one or more of dimethoxyethane, diethoxyethane, diethylene glycol dimethyl ether, triethylene glycol dimethyl ether, tetraethylene glycol dimethyl ether, 1,3-dioxolane, tetrahydrofuran, methyltetrahydrofuran, diphenyl ether, and crown ether.

In some embodiments, the electrolyte also optionally includes an additive. For example, the additive may include a negative electrode film-forming additive, or may include a positive electrode film-forming additive, or may include an additive capable of improving some performance of the battery cell, for example, an additive for improving overcharge/fast charge performance of the battery cell, an additive for improving high-temperature performance of the battery cell, or an additive for improving low-temperature performance of the battery cell.

The gel-state electrolyte includes a polymer as a framework network, and can be used in conjunction with ionic liquid-lithium salt.

The solid electrolyte includes a polymer solid electrolyte, an inorganic solid electrolyte, and a composite solid electrolyte.

As an example, the polymer of the polymer solid electrolyte may include polyether polyethylene oxide, polysiloxane, polycarbonate, polyacrylonitrile, polyvinylidene fluoride, polymethyl methacrylate, single-ion polymer, poly(ionic liquid), cellulose, and the like.

As an example, the inorganic solid electrolyte may be one or more of oxide solid electrolytes (crystalline perovskite, sodium superionic conductor, garnet, and amorphous LiPON film), sulfide solid electrolytes (crystalline lithium superionic conductor lithium germanium phosphorus sulfur, sulfur silver germanium ore, amorphous sulfide, halide solid electrolyte, nitride solid electrolyte, and hydride solid electrolyte).

As an example, the composite solid electrolyte is formed by adding inorganic solid electrolyte fillers to the polymer solid electrolyte.

The electrode assembly may be a wound structure, may also be a laminated structure, and may also be a mixed structure of winding and lamination.

In some embodiments, the electrode assembly is a wound structure. The positive electrode plate and the negative electrode plate are wound into a wound structure.

In some embodiments, the electrode assembly is a laminated structure.

As an example, multiple positive electrode plates and multiple negative electrode plates may be respectively provided, and the multiple positive electrode plates and the multiple negative electrode plates are alternately stacked.

As an example, multiple positive electrode plates may be provided, the negative electrode plate is folded to form multiple stacked folding segments, and one positive electrode plate is clamped between adjacent folding segments.

As an example, both the positive electrode plate and the negative electrode plate are folded to form multiple stacked folding segments.

As an example, multiple separators may be provided, and the separators are respectively provided between any adjacent positive electrode plates or negative electrode plates.

As an example, the separator may be continuously provided, and the separator is provided between any adjacent positive electrode plates or negative electrode plates by folding or winding.

In some embodiments, the shape of the electrode assembly may be cylindrical, flat, or polygonal prism.

In some embodiments, the electrode assembly is provided with a tab, and the tab may export current from the electrode assembly. The tab includes a positive tab and a negative tab.

In some embodiments, the battery cell may include a housing. The housing may be a steel housing, an aluminum housing, a plastic housing (for example, polypropylene), or a composite metal housing (for example, a copper-aluminum composite housing). In some embodiments, the housing may be a sealed structure or a non-sealed structure.

As an example, the battery cell may be a cylindrical battery cell, a prismatic battery cell, or a battery cell of another shape. The prismatic battery cell includes a square shell battery cell, a blade-shaped battery cell, and a polygonal prism battery (polygonal prism battery, for example, a hexagonal prism battery). This is not particularly limited in the present application.

In some embodiments, the housing includes an end cover and a shell, the shell is provided with an opening, and the end cover covers the opening. The shell may be provided with one or more openings. One or more end covers may also be provided.

In some embodiments, at least one electrode terminal is provided on the housing, and the electrode terminal is electrically connected to the tab. The electrode terminal may be directly connected to the tab, or indirectly connected to the tab through a current collecting member. The electrode terminal may be provided on the end cover or on the shell.

In some embodiments, a pressure relief mechanism is provided on the housing. The pressure relief mechanism is configured to discharge the internal gas of the battery cell.

As an example, when the internal pressure or temperature of the battery cell reaches a predetermined threshold, the pressure relief mechanism is actuated to release the internal pressure or temperature. When the internal pressure or temperature of the battery cell reaches a predetermined threshold, the pressure relief mechanism performs an action or a weak structure provided in the pressure relief mechanism is destroyed, thereby forming an opening or channel for the internal pressure or temperature to be released. The design of the threshold varies according to different design requirements. The threshold may depend on the material of one or more of the positive electrode plate, the negative electrode plate, the electrolyte, and the separator in the battery cell.

As an example, the pressure relief mechanism may be integrally formed with the shell.

As an example, the pressure relief mechanism may also be separately provided from the shell and connected.

"Actuate" mentioned in the present application refers to the pressure relief mechanism generating an action or being activated to a certain state, thereby allowing the internal pressure and temperature of the battery cell to be released. The action generated by the pressure relief mechanism may include but is not limited to: a movement of a component in the pressure relief mechanism to form an exhaust channel, at least a part of the pressure relief mechanism rupturing, breaking, being torn or opening. When the pressure relief mechanism is actuated, the high-temperature and high-pressure substances inside the battery cell is discharged outward from the actuated part as emissions. In this way, the battery cell can be relieved of pressure and temperature under controllable pressure or temperature, thereby avoiding potential more serious accidents.

In some embodiments, when the shell is a non-sealed structure, the pressure relief mechanism may be provided as a through hole for discharging the gas inside the battery cell.

The emissions from the battery cell mentioned in the present application include but are not limited to: electrolyte, dissolved or split positive electrode plate and negative electrode plate, fragments of the separator, high-temperature and high-pressure gas generated by reaction, flame, and the like.

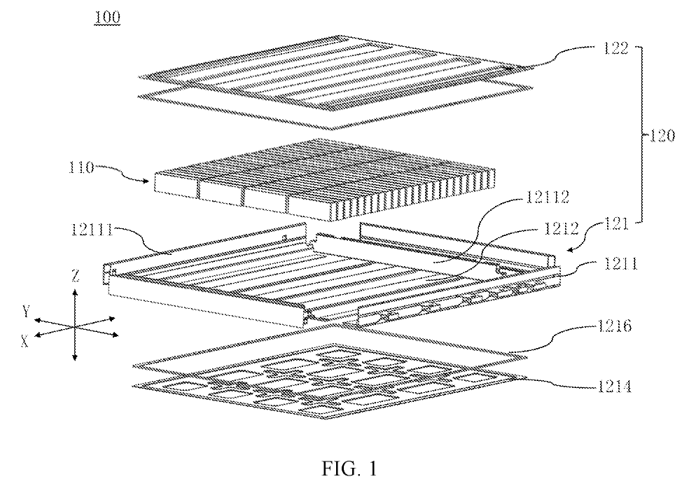

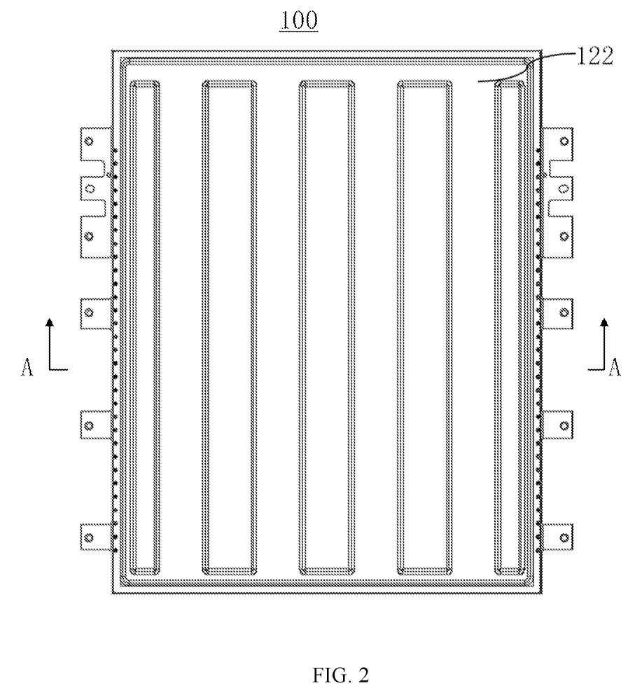

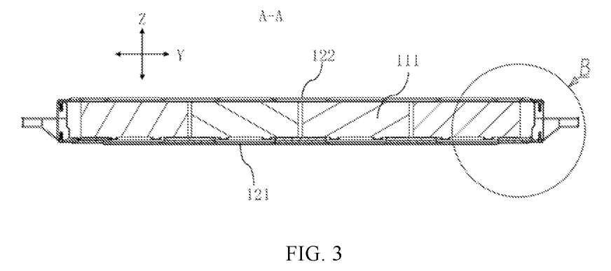

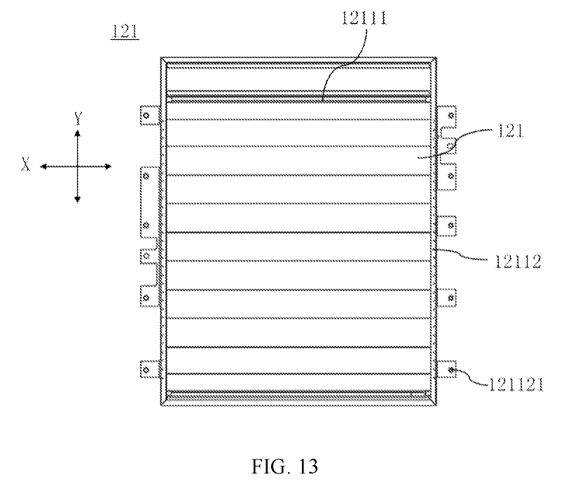

For ease of description, referring to FIGS. 1 - FIG. 13, a battery apparatus 100 according to some embodiments of the present application is used as an example for description.

The battery apparatus 100 includes a battery cell assembly 110 and a box 120. The battery cell assembly 110 includes multiple battery cells 111 arranged along a first direction X. The box 120 includes a first box body 121 and a second box body 122, the first box body 121 and the second box body 122 jointly define an accommodation space, the battery cell assembly 110 is located in the accommodation space, where the first box body 121 includes a frame 1211 and multiple structural beams 1212, the structural beams 1212 are located at the bottom of the frame 1211 and connected to the frame 1211, the multiple structural beams 1212 are spaced apart along a second direction Y, a side of the battery cell 111 facing away from the second box body 122 has an electrode terminal 1112, the electrode terminal 1112 is located between two adjacent structural beams 1212, the battery cells 111 are respectively connected to the structural beams 1212 and the second box body 122, the first direction X intersects with the second direction Y, and a plane where the first direction X and the second direction Y are jointly located intersects with the height direction Z of the box 120.

The structural beam 1212 may be a hollow beam or a solid beam.

One or more battery cell assemblies 110 may be provided, and each battery cell assembly 110 includes multiple battery cells 111.

The connection between the structural beam 1212 and the frame 1211 includes but is not limited to welding, riveting or screw connection.

The same battery cell 111 may be supported by one, two or more structural beams 1212. For example, one structural beam 1212 may be provided between two electrode terminals 1112 of the same battery cell 111.

The battery cell 111 may be fixed to both the structural beam 1212 and the second box body 122 by bonding or by applying a bead.

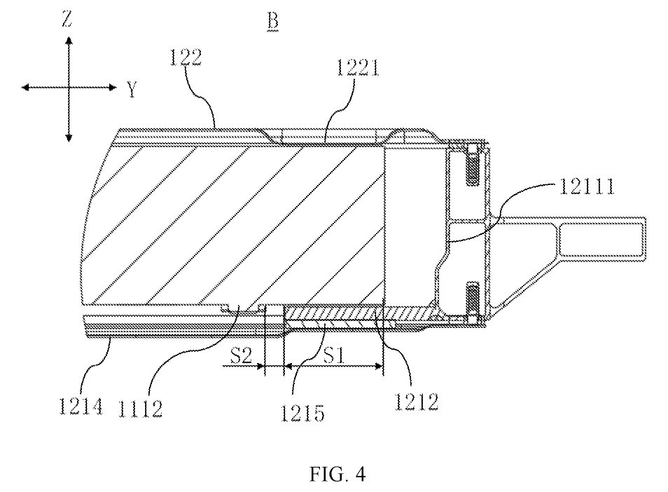

In an optional example, referring to FIG. 4, a side of the second box body 122 facing the battery cell 111 has a protruding portion 1221, the protruding portion 1221 extends in the first direction X, and the protruding portion 1221 is bonded to the battery cell 111.

When multiple battery cell assemblies 110 are provided, multiple protruding portions 1221 may be provided, the multiple protruding portions 1221 are spaced apart along the second direction Y, the multiple battery cell assemblies 110 are arranged along the second direction Y, and two adjacent battery cell assemblies 110 are bonded to the same protruding portion 1221. Optionally, the second box body 122 can be a stamping part, and the protruding portion 1221 is formed by stamping. A side of the protruding portion 1221 facing away from the battery cell 111 forms a groove.

The multiple structural beams 1212 are spaced apart, so that a contact area between the battery cell 111 and the bottom of the first box body 121 can be reduced to reduce an amount of structural adhesive and reduce costs. The reduction in the amount of structural adhesive can also reduce the weight of the box 120. Moreover, the multiple structural beams 1212 are spaced apart along the second direction Y, making the first box body 121 lighter and simpler in structure compared to the traditional first box body 121 adopting a combination of multiple plates or double-layer profile bottom plates for a large-surface structure. In addition, the battery cells 111 are respectively connected to the structural beams 1212 and the second box body 122, which can improve the main frequency (natural frequency) of the battery apparatus 100, so as to reduce the possibility of electrical connection failure of the components inside the battery apparatus 100 when there is vibration impact or when the battery cell 111 swells, thereby improving the reliability of the operation of the battery apparatus 100.

In some embodiments, the battery cell 111 is bonded to the second box body 122.

The battery cell 111 is fixed by bonding, so that the multiple battery cells 111 and the box 120 form an integrated structure, which is conducive to improving the main frequency of the battery apparatus 100, and reducing the possibility of electrical connection failure of the components inside the battery apparatus 100 when there is vibration impact or when the battery cell 111 swells, thereby improving the reliability of the operation of the battery apparatus 100.

In some embodiments, the battery cell 111 is bonded to the structural beam 1212.

The battery cell 111 is fixed by bonding, so that the multiple battery cells 111 and the box 120 form an integrated structure, which is conducive to improving the main frequency of the battery apparatus 100, and reducing the possibility of electrical connection failure of the components inside the battery apparatus 100 when there is vibration impact or when the battery cell 111 swells, thereby improving the reliability of the operation of the battery apparatus 100.

In some embodiments, the same battery cell 111 is bonded to two adjacent structural beams 1212.

Thus, compared to supporting the battery cell 111 with one structural beam 1212, the load of the structural beam 1212 can be reduced to reduce the deformation of the structural beam 1212, and reduce the possibility of electrical connection failure of the components inside the battery apparatus 100 when there is vibration impact or when the battery cell 111 swells, thereby improving the reliability of the operation of the battery apparatus 100.

In some embodiments, referring to FIGS. 4, FIG. 6, and FIG. 8, the electrode terminal 1112 is spaced apart from the structural beam 1212 along the second direction Y.

The electrode terminal 1112 and the structural beam 1212 are spaced apart, an independent arrangement space can be provided for the electrode terminal 1112 in the second direction Y, reducing the interference and short circuit caused by direct contact with the structural beam 1212, providing an installation space for the connection of a busbar and the electrode terminal 1112 during assembly, and reducing the assembly difficulty. In addition, during the operation of the battery apparatus 100, the heat generated by the electrode terminal 1112 is large, and the electrode terminal 1112 and the structural beam 1212 are spaced apart along the second direction Y, which can form a natural heat dissipation space, reducing heat accumulation and improving the overall heat dissipation.

In some embodiments, the electrode terminal 1112 on a side of the battery cell 111 facing away from the second box body 122 includes a positive electrode terminal and a negative electrode terminal; or, an electrode terminal is provided on a side of the battery cell 111 facing the second box body 122.

The positive electrode terminal and the negative electrode terminal may be provided on the side of the battery cell 111 facing away from the second box body 122; the positive electrode terminal may alternatively be provided on the side of the battery cell 111 facing away from the second box body 122, and the negative electrode terminal is provided on the side of the battery cell 111 facing the second box body 122; or, the negative electrode terminal is provided on the side of the battery cell 111 facing away from the second box body 122, and the positive electrode terminal is provided on the side of the battery cell 111 facing the second box body 122.

Thus, the electrode terminal can be set on one side or two sides of the battery cell 111 along a height direction Z of the box 120 according to different usage requirements.

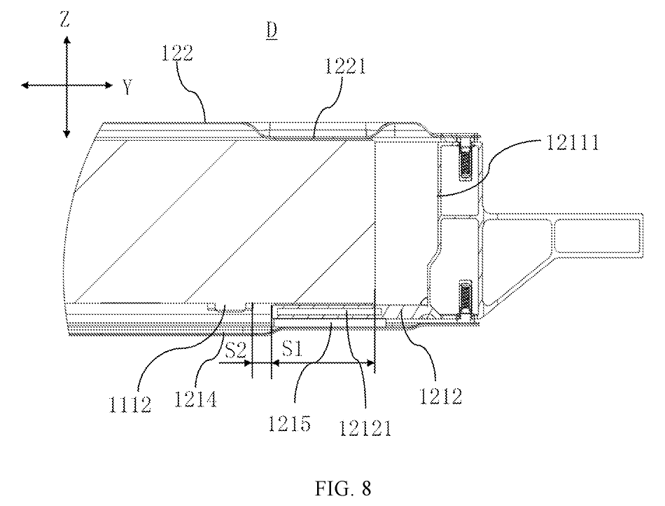

In some embodiments, referring to FIGS. 4 and FIG. 8, the electrode terminal 1112 on the side of the battery cell 111 facing away from the second box body 122 includes the positive electrode terminal and the negative electrode terminal. In two adjacent structural beams 1212, along the second direction Y, the distance from the two adjacent structural beams 1212 to the same electrode terminal 1112 is different, and the structural beam 1212 closest to the electrode terminal 1112 is a first structural beam, along the height direction Z of the box 120, a dimension of an orthographic projection of the first structural beam on the battery cell 111 in the second direction Y is S1, and the spacing between the electrode terminal 1112 and the first structural beam along the second direction Y is S2. When the structural beam 1212 is a solid beam, the ratio of S1/S2 ranges from 0.25 to 87.5; or when the structural beam 1212 is a hollow beam, the ratio of S1/S2 ranges from 0.65 to 87.5.

When the structural beam 1212 is a hollow beam, the cavity inside the structural beam 1212 can serve as a heat exchange flow channel 12121 or as a weight reduction cavity.

In an example, the battery apparatus 100 further includes a reinforcing strip. The structural beam 1212 has an accommodation cavity, the accommodation cavity extends in the first direction X and runs through two ends of the structural beam 1212, and the reinforcing strip is provided in the accommodation cavity, where the strength of the reinforcing strip is greater than the strength of the structural beam 1212. The cross-sectional shape of the reinforcing strip may be, but is not limited to, circular, square, or elliptical, which can improve the overall rigidity of the structural beam 1212 to reduce the deformation of the structural beam 1212 when bearing load.

Limiting the ratio of S1/S2 within the above numerical range allows, on one hand, when the structural beam 1212 is a metal beam, for a certain safe distance between the electrode terminal 1112 and the structural beam 1212 to reduce the possibility of short circuit, and facilitate the installation of electrical connection components such as the electrode terminal 1112 and the busbar. On the other hand, this ensures that the structural beam 1212 has a certain strength to resist deformation, so as to reduce the degree of bending deformation of the structural beam 1212. This reduces the possibility of electrical connection failure of the components inside the battery apparatus 100 when there is vibration impact or when the battery cell 111 swells, thereby improving the reliability of the operation of the battery apparatus 100.

In some embodiments, referring to FIGS. 4 and FIG. 8, when the structural beam 1212 is a solid beam, the ratio of S1/S2 ranges from 0.4 to 87.5; and when the structural beam 1212 is a hollow beam, the ratio of S1/S2 ranges from 0.65 to 87.5.

Thus, on one hand, the safe distance between the electrode terminal 1112 and the structural beam 1212 can be further improved to reduce the possibility of short circuit, and facilitate the installation of electrical connection components such as the electrode terminal 1112 and the busbar. On the other hand, this ensures that the structural beam 1212 has a certain strength to resist deformation, so as to reduce the occurrence of bending deformation of the structural beam 1212. This reduces the possibility of electrical connection failure of the components inside the battery apparatus 100 when there is vibration impact or when the battery cell 111 swells, thereby improving the reliability of the operation of the battery apparatus 100.

In some embodiments, referring to FIGS. 4 and FIG. 8, when the structural beam 1212 is a solid beam, a value of S2 ranges from 8 mm to 775 mm; and when the structural beam 1212 is a hollow beam, a value of S2 ranges from 8 mm to 575 mm.

Under the premise of taking into account the support strength of the structural beam 1212 and the insulation distance of the electrode terminal 1112, limiting the value of S2 within the above range can meet the needs of different sizes of battery cells 111 along the second direction Y, so as to select appropriate values for different sizes of battery cells 111.

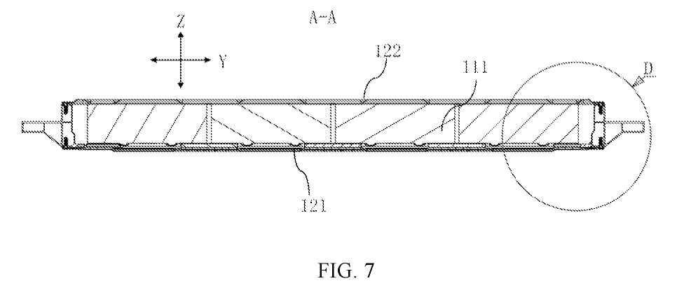

In some embodiments, referring to FIGS. 7 and FIG. 8, the interior of the structural beam 1212 has a heat exchange flow channel 12121, and an inlet and an outlet respectively communicating with the heat exchange flow channel 12121.

The heat exchange flow channel 12121 may be a straight flow channel extending along the first direction X, or a bent flow channel, and the cross-sectional shape of the heat exchange flow channel 12121 may be, but is not limited to, circular, square, or other irregular shapes.

One or more heat exchange flow channels 12121 may be provided inside the structural beam 1212. When multiple heat exchange flow channels 12121 are provided in the structural beam 1212, the multiple heat exchange flow channels 12121 may be connected in series or in parallel. The heat exchange flow channels 12121 of two adjacent structural beams 1212 may be connected in series or in parallel.

The heat generation near the pole of the battery cell 111 is large, and the temperature of the battery cell 111 can be effectively controlled by cooling the region near the pole of the battery cell 111. In addition, the heat exchange flow channel 12121 is provided in the structural beam 1212, which can reduce the manufacturing difficulty compared to the traditional battery apparatus 100 using a water cooling plate.

In some embodiments, the side of the battery cell 111 facing away from the second box body 122 is provided with a pressure relief mechanism 1111, where the pressure relief mechanism 1111 is configured to actuate when the battery cell 111 experiences thermal runaway and an internal pressure of the battery cell 111 reaches a set value to release emissions, and the pressure relief mechanism 1111 is provided between two adjacent structural beams 1212.

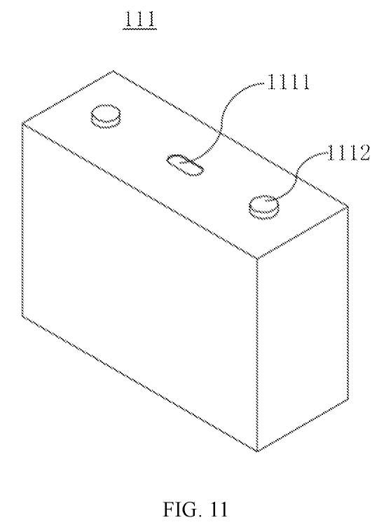

FIG. 11 is an axonometric view of the battery cell 111 with the pressure relief mechanism 1111 provided on the side having the electrode terminal 1112.

The pressure relief mechanism 1111 is located between two adjacent structural beams 1212, providing a direct discharge channel for high-pressure gas and emissions during thermal runaway, facilitating the diffusion of high-temperature emissions between two adjacent structural beams 1212. Compared to the traditional closed bottom plate design, placing the pressure relief mechanism 1111 between two adjacent structural beams 1212 can reduce the obstruction of the emissions by the bottom of the box 120, concentrating a pressure relief direction, effectively reducing the risk of internal pressure accumulation, and improving the safety of the battery apparatus 100. In other embodiments, the pressure relief mechanism 1111 may also be provided on the side of the battery cell 111 facing the second box body 122, that is, the pressure relief mechanism 1111 and the electrode terminal 1112 face away from each other.

In some embodiments, referring to FIGS. 1 and FIG. 4, the frame 1211 includes two first side beams 12111 spaced apart along the second direction Y, and along the second direction Y, the two outermost structural beams 1212 are connected to the two first side beams 12111 in one-to-one correspondence.

The frame 1211 further includes second side beams 12112 spaced apart along the first direction X, and at least some of the structural beams 1212 may be connected to the second side beams 12112, specifically by welding.

The first side beam 12111 serves as the lateral boundary support of the frame 1211, which can increase the overall rigidity of the first box body 121, reduce the risk of local deformation caused by uneven force, and reduce the possibility of electrical connection failure of the components inside the battery apparatus 100 when there is vibration impact or when the battery cell 111 swells, thereby improving the reliability of the operation of the battery apparatus 100.

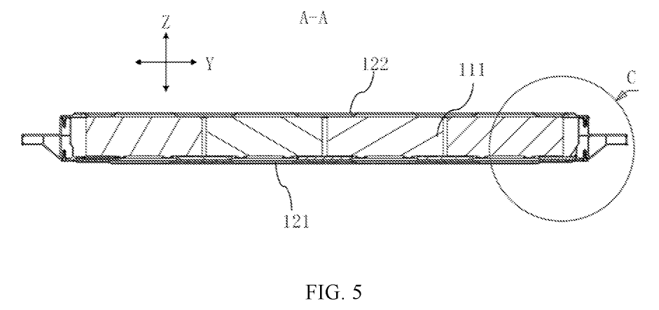

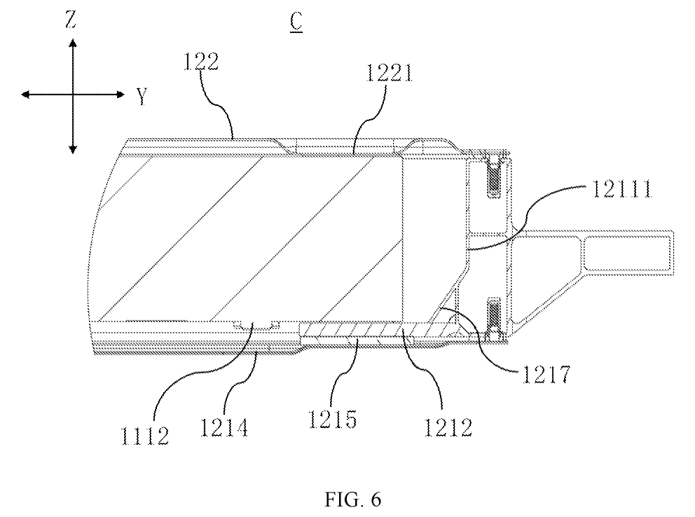

In some embodiments, referring to FIGS. 5 and FIG. 6, in the second direction Y, a reinforcing rib 1217 is connected between the outermost structural beam 1212 and the first side beam 12111, and the reinforcing rib 1217 extends in the first direction X.

The connection between the reinforcing rib 1217 and the first side beam 12111 and between the reinforcing rib 1217 and the structural beam 1212 may be fixed by welding, riveting, or screw connection.

One or more reinforcing ribs 1217 may be provided between the same first side beam 12111 and the structural beam 1212, and when multiple reinforcing ribs 1217 are provided, the multiple reinforcing ribs 1217 may be arranged along the first direction X.

Thus, the connection strength between the outermost structural beam 1212 along the second direction Y and the first side beam 12111 is further improved to increase the overall rigidity of the first box body 121, reduce the risk of local deformation caused by uneven force, and reduce the possibility of electrical connection failure of the components inside the battery apparatus 100 when there is vibration impact or when the battery cell 111 swells, thereby improving the reliability of the operation of the battery apparatus 100.

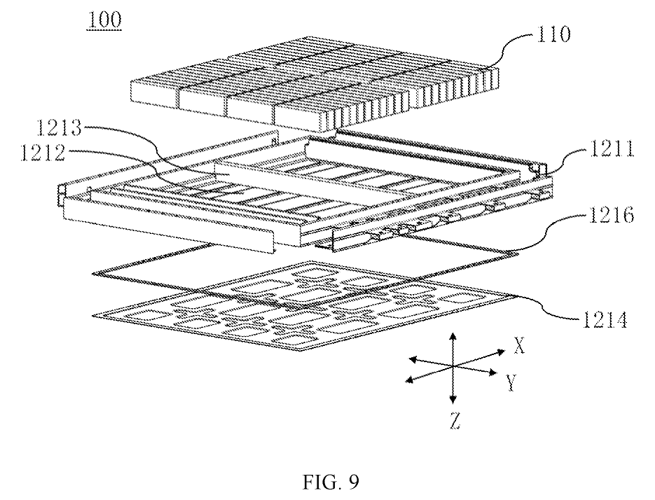

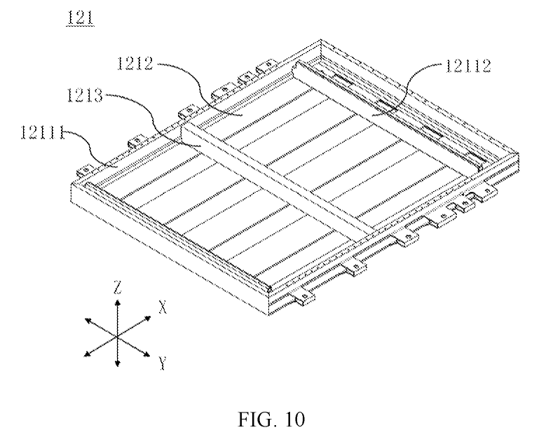

In some embodiments, referring to FIGS. 9 and FIG. 10, the first box body 121 further includes a spacer beam 1213, where a length direction of the spacer beam 1213 is the same as the second direction Y, and the battery cell assemblies 110 are respectively provided on two sides of the spacer beam 1213 along the first direction X,

The spacer beam 1213 is connected to at least some of the structural beams 1212, and/or, the spacer beam 1213 is connected to the frame 1211.

The connection between the spacer beam 1213 and the structural beam 1212 and the connection between the spacer beam 1213 and the frame 1211 include, but are not limited to, welding, riveting, or screw connection.

The arrangement of the spacer beam 1213 can further improve the bending strength of the multiple structural beams 1212 to improve the main frequency of the battery apparatus 100, so as to reduce the possibility of electrical connection failure of the components inside the battery apparatus 100 when there is vibration impact or when the battery cell 111 swells, thereby improving the reliability of the operation of the battery apparatus 100.

In some embodiments, referring to FIG. 4, the first box body 121 further includes a protective plate 1214, where the protective plate 1214 is located on a side of the first box body 121 facing away from the second box body 122 and is connected to the first box body 121.

The connection between the protective plate 1214 and the first box body 121 includes screw connection, riveting, or welding.

The arrangement of the protective plate 1214 can protect the side of the first box body 121 facing away from the second box body 122, especially when the battery apparatus 100 is applied in new energy vehicles, external impact and collision can be absorbed.

In some embodiments, referring to FIG. 4, the first box body 121 further includes a buffer member 1215, and the buffer member 1215 is provided between the protective plate 1214 and the structural beam 1212.

The buffer member 1215 may be made of foam, polyurethane, or fiber-reinforced thermoplastic material.

The buffer member 1215 is provided between the protective plate 1214 and the first box body 121, so that external impact can be buffered to improve the protection of the battery cell 111, thereby improving the reliability of the operation of the battery cell 111.

In some embodiments, referring to FIG. 1, the first box body 121 further includes a sealing member 1216, where the sealing member 1216 is arranged around the accommodation space, and the sealing member 1216 is provided between the protective plate 1214 and the first box body 121.

The sealing member 1216 may be a sealing gasket, a sealing ring, or a sealant.

The sealing member 1216 can prevent external dust, water, and the like from entering the battery apparatus 100 to protect the components inside the battery apparatus 100.

In some embodiments, the structural beam 1212 is a flat beam, and a thickness direction of the structural beam 1212 is the same as the height direction Z of the box 120.

In an example, when the structural beam 1212 is a solid beam, the thickness of the structural beam 1212 may be, but is not limited to, 3 mm to 8 mm, and the dimension of the structural beam 1212 along the second direction Y may be, but is not limited to, 20 mm to 700 mm. When the structural beam 1212 is a hollow beam, the thickness of the structural beam 1212 may be, but is not limited to, 4.4 mm to 8 mm, the dimension of the structural beam 1212 along the second direction Y may be, but is not limited to, 40 mm to 700 mm, and a wall thickness of the structural beam 1212 may be, but is not limited to, 1.8 mm to 3 mm. In other examples, the wall thickness of the structural beam 1212 may be above 3 mm.

Thus, this can reduce the excessive occupation of the size of the box 120 in the height direction Z by the structural beam 1212, so as to reduce the occupied space of the box 120, which is especially suitable for scenes where the space in the height direction Z of the box 120 is limited.

In some embodiments, the size of the battery cell 111 along the second direction Y may be, but is not limited to, 200 mm to 2000 mm.

The battery cell 111 may be a square shell battery cell or a blade battery cell, which is not specifically limited here.

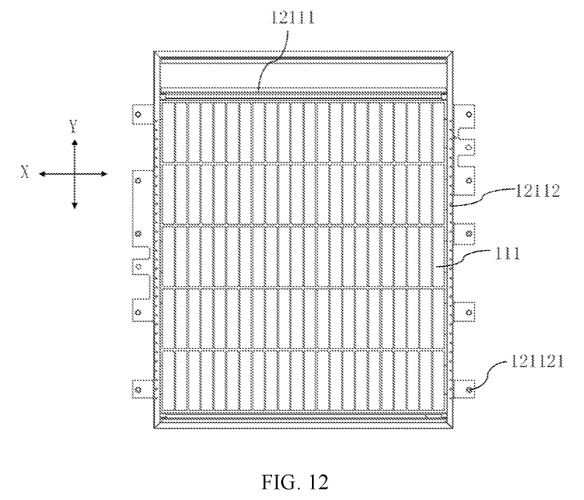

In some embodiments, referring to FIGS. 12 and FIG. 13, the frame 1211 includes two second side beams 12112 spaced apart along the first direction X, the structural beam 1212 is connected to the second side beams 12112, the second side beams 12112 are configured to connect to a vehicle, and the first direction X is configured to intersect with a traveling direction of the vehicle.

Exemplarily, the second side beam 12112 is provided with a mounting hole 121121, which can be connected to the vehicle through fasteners such as bolts passing through the mounting hole.

The arrangement direction (first direction X) of the multiple battery cells 111 of the same battery cell assembly 110 in FIGS. 12 and FIG. 13 is different from that in FIG. 1. The second side beam 12112 in FIGS. 12 and FIG. 13 is used as a mounting beam for fixing the battery apparatus 100. The first side beam 12111 in FIG. 1 is used as a mounting beam, and the second side beam 12112 in FIG. 1 is connected to the first side beam 12111 and used as an expansion beam, that is, when the battery cell 111 swells, the swelling force in the arrangement direction of the multiple battery cells 111 of the same battery cell assembly 110 can be resisted.

The second side beam 12112 is configured to connect to the vehicle, and the second side beam 12112 is used as a mounting beam. Since the mounting beam has the characteristics of high strength and impact resistance, the swelling force of the battery cell 111 along the first direction X can be resisted to reduce the deformation of the frame 1211. Compared to the structure where the arrangement direction of the multiple battery cells 111 in the same battery cell assembly 110 is the same as the traveling direction of the vehicle, the deformation of the frame 1211 can be reduced without increasing the weight and strength of the side beam of the frame 1211 along the first direction X, which is conducive to reducing the weight of the first box body 121.

In some embodiments, referring to FIGS. 1, FIG. 14, and FIG. 15, the first box body 121 has a current flow channel 1218121, the interior of the structural beam 1212 has a heat exchange flow channel 12121, and the heat exchange flow channels 12121 of two adjacent structural beams 1212 communicate through the current flow channel 1218121.

The heat exchange flow channels 12121 inside the multiple structural beams 1212 can achieve series and/or parallel connection through the current flow channel 1218121.

One or more heat exchange flow channels 12121 in the structural beam 1212 may be provided. The structures of the heat exchange flow channels 12121 in the multiple structural beams 1212 may be the same or different. Exemplarily, the heat exchange flow channels 12121 inside some of the structural beams 1212 may extend substantially in a U-shaped path, that is, a heat exchange medium may flow along a U-shaped path. The heat exchange flow channels 12121 inside the structural beams 1212 may also be straight flow channels or bent flow channels, and the structures of different heat exchange flow channels 12121 can be specifically selected according to the series and/or parallel connection of the multiple structural beams 1212.

The battery cell 111 has an electrode terminal 1112. In one example, the electrode terminal 1112 is provided on the side of the battery cell 111 facing away from the second box body 122, the electrode terminal 1112 is located between two adjacent structural beams 1212, and the electrode terminal 1112 is spaced apart from the structural beam 1212 along the second direction Y; or, the electrode terminal 1112 is provided on the side of the battery cell 111 facing the second box body 122. In another example, along the height direction Z of the box 120, electrode terminals 1112 are respectively provided on two sides of the battery cell 111, where the electrode terminal 1112 on the side of the battery cell 111 facing away from the second box body 122 is located between two adjacent structural beams 1212 and is spaced apart from the structural beam 1212 along the second direction Y.

A heat exchange medium can be introduced into the current flow channel 1218121 to adjust the temperature of the battery cell 111. The heat exchange medium can be air, water, or other organic or inorganic solvents, such as oil.

The multiple structural beams 1212 are spaced apart along the second direction Y. During welding, compared to the traditional battery apparatus 100 using a combination of multiple profile bottom plates to form a water cooling plate connected to the frame 1211, a welding area can be reduced, production efficiency can be improved, manufacturing costs can be reduced, the weight of the box can be reduced, and material usage can be saved. In addition, the interior of the structural beam 1212 has a heat exchange flow channel 12121, the first box body 121 has a current flow channel 1218121, and the heat exchange flow channels 12121 of two adjacent structural beams 1212 communicate through the current flow channel 1218121, which can achieve series or parallel connection of the heat exchange flow channels 12121 of two adjacent structural beams 1212 according to requirements, so that the flow channels can be flexibly designed according to requirements. Compared to the traditional use of water cooling plates for heat exchange with battery cells, the complexity of the structure is reduced.

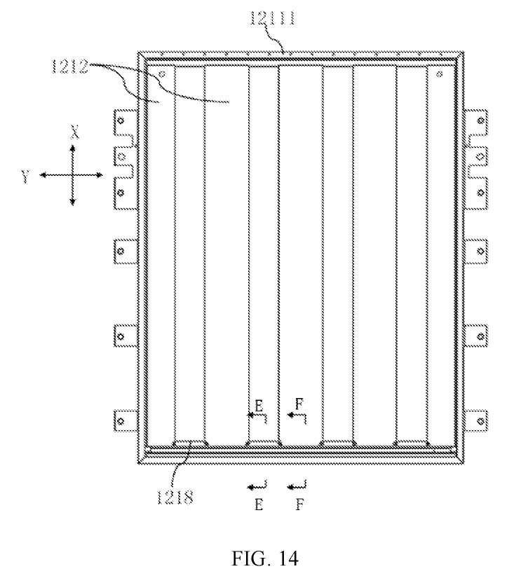

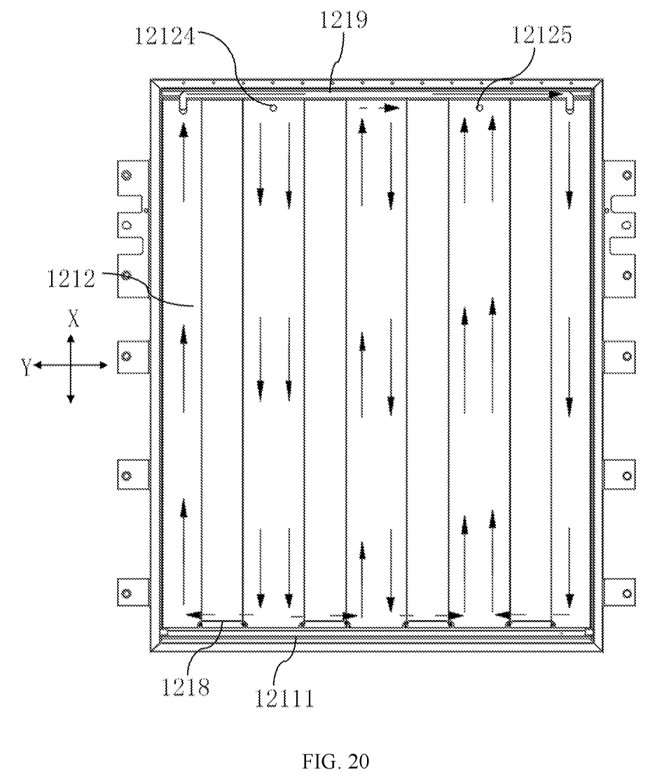

In some embodiments, referring to FIGS. 14 - FIG. 18, the first box body 121 includes a current collector member 1218, the frame 1211 includes two first side beams 12111 spaced apart along the first direction X, at least one end of the structural beam 1212 along the first direction X is connected to the current collector member 1218, the structural beam 1212 is connected to the first side beam 12111 through the current collector member 1218, the current collector member 1218 includes at least one current collector unit 12181, and the interior of the current collector unit 12181 has a current flow channel 1218121.

One or more current collector units 12181 may be provided. One or more current flow channels 1218121 in the current collector unit 12181 may be provided.

The connection between two adjacent structural beams 1212 and the current collector unit 12181 includes, but is not limited to, welding, bonding, or integral molding.

The connection between the current collector member 1218 and the first side beam 12111 includes, but is not limited to, welding or bonding.

The structural beam 1212 is connected to the first side beam 12111 through the current collector member 1218. During assembly, the current collector member 1218 may be first connected to the first side beam 12111, and then the structural beam 1212 may be connected to the current collector member 1218, achieving partial assembly for convenient installation. In addition, setting the current collector member 1218 as a separate component facilitates the production of the current flow channel 1218121.

In some embodiments, the structural beam 1212 is welded to the current collector member 1218; and/or, the frame 1211 is welded to the current collector member 1218.

In one example, the welding of the structural beam 1212 and the frame 1211 may respectively be welded to the current collector member 1218 by friction welding or laser welding.

The structural beam 1212 is directly welded to the current collector member 1218, eliminating the complex flow channel connection structure in traditional profile bottom plate splicing, significantly reducing the number of welds and welding area, and reducing the possibility of leakage caused by numerous welds in traditional profile splicing, thereby improving sealing. In addition, the welding of the structural beam 1212 to the frame 1211 through the current collector member 1218 forms a rigid connection, improving the overall vibration resistance and impact resistance of the box 120, which is conducive to improving the main frequency of the battery apparatus 100.

In some embodiments, the current collector member 1218 further includes a connection portion 12182, and the connection portion 12182 is respectively connected to two ends of the current collector unit 12181 along the second direction Y. The end of the structural beam 1212 along the first direction X is welded to the connection portion 12182; and/or, the first side beam 12111 is welded to the connection portion 12182.

In one example, the current collector unit 12181 is respectively welded to two adjacent structural beams 1212.

The connection between the connection portion 12182 and the current collector unit 12181 includes, but is not limited to, bonding, welding, or integral molding.

In one example, the connection portion 12182 is a strip structure extending along the second direction Y.

The connection portion 12182 serves as an intermediate transition component between the structural beam 1212 and the frame 1211. The connection portion 12182 is used as an intermediate transition component and is welded to the structural beam 1212 and/or the first side beam 12111, facilitating the manufacturing of the first box body 121.

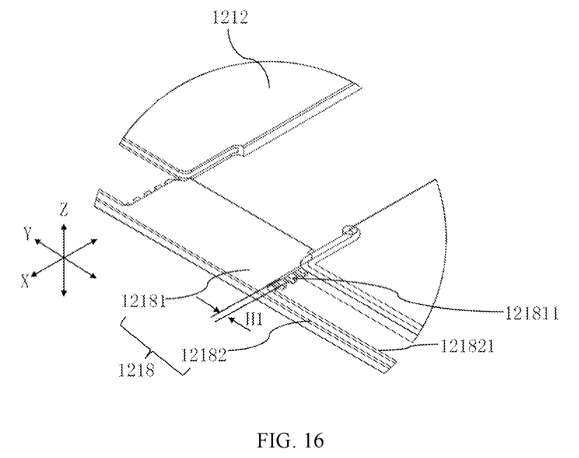

In some embodiments, referring to FIGS. 16 and FIG. 18, the current collector member 1218 further includes inserting portions 121811, the inserting portions 121811 are respectively provided at two ends of the current collector unit 12181 along the second direction Y. Along the second direction Y, the inserting portion 121811 at one end of the current collector unit 12181 is a first inserting portion, the inserting portion 121811 at the other end of the current collector unit 12181 is a second inserting portion, where the first inserting portion is inserted into the heat exchange flow channel 12121 of one of the two adjacent structural beams 1212, and the second inserting portion is inserted into the heat exchange flow channel 12121 of the other of the two adjacent structural beams 1212.

In some examples, the inserting portion 121811 may be a hollow ring structure or a solid insertion strip.

The inserting portion 121811 and the current collector unit 12181 may be integrally formed or fixed by welding or screw connection.

After the inserting portion 121811 is inserted into the heat exchange flow channel 12121, an internal support structure is formed, and the welding of the current collector unit 12181 and the structural beam 1212 can be achieved by friction welding. Under the pressure of friction welding, the inserting portion 121811 can reduce the possibility of plastic deformation or collapse of the thin-walled heat exchange flow channel 12121 due to compression. This ensures good sealing during the friction welding process and reduces the possibility of the heat exchange flow channel 12121 being crushed. After welding, the heat exchange flow channel 12121 and the current flow channel 1218121 communicate more smoothly. In addition, since the structural beam 1212 bears the weight from the battery cell 111, the inserting portion 121811 can disperse part of the stress to reduce the stress at a welding position between the current collector unit 12181 and the structural beam 1212, thereby reducing the possibility of fracture of the structural beam 1212 at a weld position due to excessive stress, and improving the reliability of the structural beam 1212 at a connection position of the current collector member 1218.

In some embodiments, referring to FIG. 16, in the second direction Y, the depth of the inserting portion 121811 inserted into the heat exchange flow channel 12121 is H1, and the value of H1 ranges from 5 mm to 10 mm.

Through the insertion depth of 5 mm to 10 mm, the inserting portion 121811 can have sufficient support force during the friction welding process to disperse the stress during the welding process, while not wasting too much material to save manufacturing costs. In addition, when the structural beam 1212 bears the gravity from the battery cell 111 or when the battery apparatus 100 is in a vibrating environment, limiting H1 within the above numerical range can disperse stress and reduce the possibility of fracture of the structural beam 1212 at the weld position due to excessive stress, improving the reliability of the structural beam 1212 at the connection position of the current collector member 1218.

In some embodiments, referring to FIG. 16, multiple current flow channels 1218121 are provided, the multiple current flow channels 1218121 are spaced apart along the second direction Y, a support rib 1218122 is formed between two adjacent current flow channels 1218121, the support rib 1218122 extends from two ends of a current flow channel 1218121 along the second direction Y, and the part of the support rib 1218122 extending from the end of the current flow channel 1218121 along the second direction Y constitutes the inserting portion 121811.

One or more support ribs 1218122 at the same end of the current flow channel 1218121 along the second direction Y may be provided.

When multiple support ribs 1218122 at the same end of the current flow channels 1218121 along the second direction Y are provided, the stress during the friction welding process can be better dispersed to reduce the possibility of the current flow channel 1218121 being crushed and causing the current flow channel 1218121 to be blocked.

The arrangement of the support rib 1218122 can reduce the possibility of the current flow channel 1218121 being crushed during the friction welding process, so that the current flow channel 1218121 and the heat exchange flow channel 12121 can communicate smoothly after welding, improving welding quality.

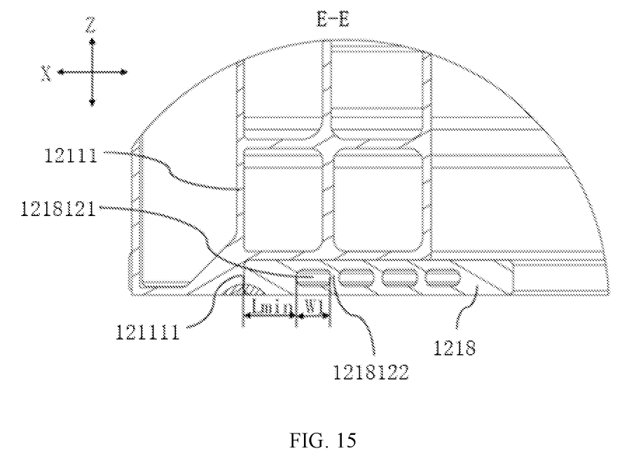

In some embodiments, referring to FIG. 15, the size of the current flow channel 1218121 along the first direction X is W1, and the value of W1 ranges from 4 mm to 10 mm.

Thus, when the current collector unit 12181 is friction welded to the frame 1211, the possibility of the current flow channel 1218121 being crushed due to excessive friction welding pressure can be reduced, improving welding quality, so that the current flow channel 1218121 and the heat exchange flow channel 12121 can communicate smoothly after welding.

In some embodiments, referring to FIG. 18, the current collector unit 12181 includes a main body portion 121812 and a tube portion 121813, the interior of the main body portion 121812 has an accommodation cavity, the accommodation cavity runs through two ends of the main body portion 121812 along the second direction Y, the tube portion 121813 is located in the accommodation cavity, along the second direction Y, two ends of the tube portion 121813 extend from two ends of the main body portion 121812, the part of the tube portion 121813 extending from the main body portion 121812 constitutes the inserting portion 121811, the interior of the tube portion 121813 has a current flow channel 1218121, and the current flow channel 1218121 runs through two ends of the tube portion 121813.

In this embodiment, both the main body portion 121812 and the tube portion 121813 may be made of the same non-metallic or metallic material, or the main body portion 121812 and the tube portion 121813 may be made of different materials.

During friction welding, the tube portion 121813 may provide support for the heat exchange flow channel 12121 to reduce the possibility of the current flow channel 1218121 being crushed.

In some embodiments, the strength of the tube portion 121813 is greater than the strength of the main body portion 121812.

The materials of the tube portion 121813 and the main body portion 121812 can use two different materials, such as metallic or non-metallic materials. For example, the main body portion 121812 is made of metallic material, and the tube portion 121813 is made of non-metallic or metallic material. Specifically, the main body portion 121812 can be made of aluminum alloy material, the tube portion 121813 may be a flat steel tube, and the tube portion 121813 and the accommodation cavity are fixed by interference fit.

The strength of the tube portion 121813 is greater than the strength of the main body portion 121812, which can reduce the possibility of the current flow channel 1218121 being crushed during friction welding. In addition, due to the greater strength of the tube portion 121813, a flow area of the current flow channel 1218121 can be made larger to reduce the flow resistance of the heat exchange medium.

In some embodiments, referring to FIG. 16, the current collector member 1218 further includes a connection portion 12182, the connection portion 12182 is respectively connected to each end of the current collector unit 12181 along the second direction Y, and the connection portion 12182 is respectively connected to the end of the structural beam 1212 and the frame 1211.

The current collector unit 12181 and the connection portion 12182 may be integrally formed or fixed by welding.

The connection portion 12182 serves as an intermediate transition component between the structural beam 1212 and the frame 1211. After the connection portion 12182 is connected to the frame 1211, the connection between the connection portion 12182 and the structural beam 1212 can be performed. The assembly operation can be facilitated through segmented assembly.

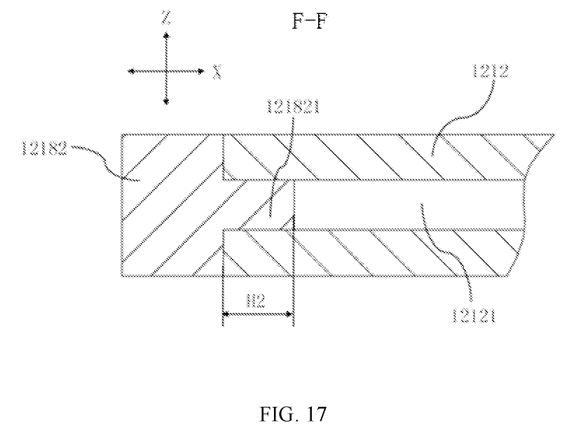

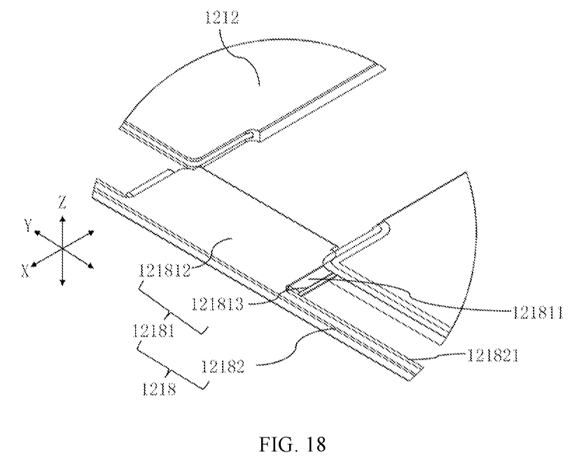

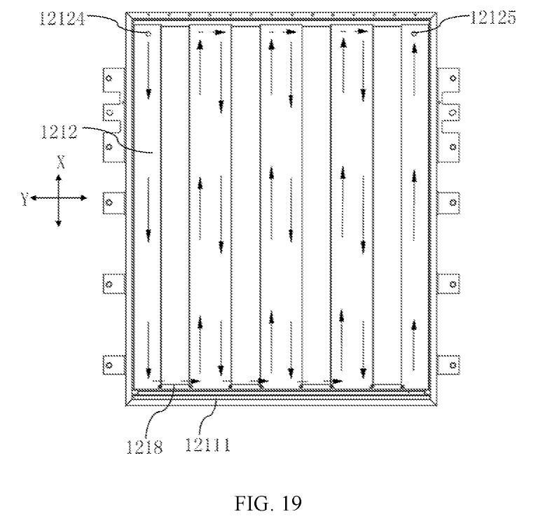

In some embodiments, referring to FIGS. 16 and FIG. 17, the connection portion 12182 is provided with a protrusion 121821 on the side facing the structural beam 1212, and the protrusion 121821 is inserted into the heat exchange flow channel 12121.

The cross-sectional shape of the protrusion 121821 may be, but is not limited to, square, U-shaped, or hemispherical, and the cross-section of the protrusion 121821 is perpendicular to the second direction Y.

After the protrusion 121821 is inserted into the heat exchange flow channel 12121, a support structure is formed, and the welding of the current collector member 1218 and the structural beam 1212 can be achieved by friction welding. Under the pressure of friction welding, the protrusion 121821 can reduce the possibility of plastic deformation or collapse of the thin-walled heat exchange flow channel 12121 due to compression. This ensures good sealing during the friction welding process and reduces the possibility of the heat exchange flow channel 12121 being crushed. After welding, the heat exchange flow channel 12121 and the current flow channel 1218121 communicate more smoothly. In addition, since the structural beam 1212 bears the weight from the battery cell 111, the protrusion 121821 can disperse part of the stress to reduce the stress at the welding position between the current collector unit 12181 and the structural beam 1212, thereby reducing the possibility of fracture of the structural beam 1212 at the weld position due to excessive stress, and improving the reliability of the structural beam 1212 at the connection position of the current collector member 1218.

In some embodiments, referring to FIG. 17, the size of the protrusion 121821 along the first direction X is H2, and the value of H2 ranges from 5 mm to 10 mm.

Setting H2 within the above range allows the protrusion 121821 to have sufficient support force during the friction welding process to disperse the stress during the welding process, while not wasting too much material to save manufacturing costs. In addition, when the structural beam 1212 bears the gravity from the battery cell 111 or when the battery apparatus 100 is in a vibrating environment, limiting H2 within the above numerical range can disperse stress and reduce the possibility of fracture of the structural beam 1212 at the weld position due to excessive stress, improving the reliability of the structural beam 1212 at the connection position of the current collector member 1218.

In some embodiments, referring to FIG. 14, more current collector units 12181 are provided, two adjacent current collector units 12181 are spaced apart along the second direction Y, and two adjacent current collector units 12181 are connected through the connection portion 12182.

Specifically, N current collector units 12181 are provided, N+1 structural beams 1212 may be provided, and N is an integer greater than 2.

Compared to the method of connecting each current collector unit 12181 separately to the frame 1211, integrating multiple current collector units 12181 into one integral component only requires connecting this integral component to the frame 1211 and then connecting the current collector units 12181 to the structural beams 1212 one by one, saving the time for installing multiple current collector units 12181 separately to the frame 1211, improving assembly efficiency. In addition, the installation deviation caused by the separate installation of the current collector units 12181 can be reduced.

In some embodiments, referring to FIG. 15, the frame 1211 includes a first side beam 12111, the first side beam 12111 is connected to the current collector member 1218, the first side beam 12111 has a first abutting surface 121111 that abuts against the current collector member 1218 along the first direction X, along the first direction X, the minimum distance between the heat exchange flow channel 12121 and the first abutting surface 121111 is L min, and the value of L min ranges from 5 mm to 15 mm.

Optionally, the connection between the first side beam 12111 and the current collector member 1218 can be welding, specifically through friction welding.

When the current collector member 1218 and the frame 1211 are friction welded, setting L min within the above range can reduce the possibility of the heat exchange flow channel 12121 being crushed due to friction welding, improving welding quality.

In some embodiments, the frame 1211 includes two first side beams 12111 spaced apart along the first direction X, the structural beam 1212 is directly welded to the first side beam 12111, and at least one first side beam 12111 has a current flow channel 1218121 inside.

In one example, the first side beam 12111 has a cavity, and the cavity of the first side beam 12111 serves as the current flow channel 1218121.

Directly connecting the structural beam 1212 to the first side beam 12111 can reduce the welding area, reduce manufacturing costs, and improve the production efficiency of the battery apparatus 100, while reducing the complexity of the structure and facilitating manufacturing.

In some embodiments, the heat exchange flow channels 12121 inside the multiple structural beams 1212 are connected in series or in parallel to form a heat exchange flow path, the heat exchange flow path has a first interface 12124 and a second interface 12125, one of the first interface 12124 and the second interface 12125 is configured to introduce a heat exchange medium, and the other of the first interface 12124 and the second interface 12125 is configured to discharge the heat exchange medium.

The first interface 12124 may be provided in one of the two outermost structural beams 1212 along the second direction Y, the second interface 12125 is provided in the other of the two outermost structural beams 1212 along the second direction Y, and the first interface 12124 and the second interface 12125 may be located at the ends of the structural beams 1212 away from the current collector member 1218.

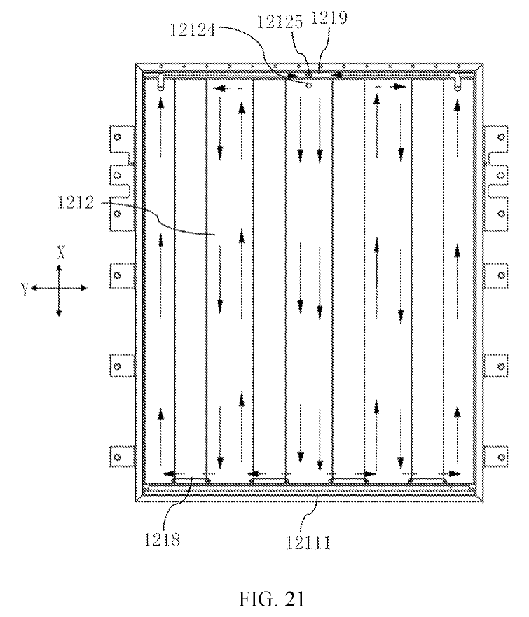

FIG. 19 is a structural diagram of the heat exchange flow channels 12121 inside the multiple structural beams 1212 connected in series, the direction of the arrows in FIG. 19 is the flow direction of the heat exchange medium in the heat exchange flow path, along the second direction Y, the heat exchange medium flows from the outermost structural beam 1212 through the middle structural beam 1212 and finally flows out from the other outermost structural beam 1212.

The heat exchange flow channels 12121 inside the multiple structural beams 1212 are connected in series, which can extend the heat exchange time under the premise of constant flow rate to achieve more sufficient heat transfer, with the characteristics of low resistance and small pressure drop. The heat exchange flow channels 12121 inside the multiple structural beams 1212 are connected in parallel, which can reduce pressure loss, and the synchronous cooling of the parallel branches makes the inlet temperature of each branch of the heat exchange flow path consistent. This is conducive to reducing the temperature difference in different regions of the battery cell 111 and making the temperature of different battery cells 111 more uniform.

In some embodiments, referring to FIGS. 20 and FIG. 21, more than three structural beams 1212 are provided, the heat exchange flow channels 12121 inside the multiple structural beams 1212 are connected in series and in parallel to form a heat exchange flow path, the heat exchange flow path has a first interface 12124 and a second interface 12125, one of the first interface 12124 and the second interface 12125 is configured to introduce a heat exchange medium, and the other of the first interface 12124 and the second interface 12125 is configured to discharge the heat exchange medium.

To illustrate with three structural beams 1212, the heat exchange flow channels 12121 of two structural beams 1212 are connected in series and then connected in parallel with the heat exchange flow channel 12121 of another structural beam 1212, forming a mixed flow path with both series and parallel connections.

To illustrate with five structural beams 1212, the two outermost structural beams 1212 along the second direction Y are connected, specifically through a connection pipe 1219, and another two structural beams 1212 adjacent to the two outermost structural beams 1212 are provided with a first interface 12124 and a second interface 12125, where the first interface 12124 and the second interface 12125 are respectively located at an end of the structural beam 1212 facing away from the current collector member 1218, and the flow direction of the heat exchange medium is as shown by the arrows in FIGS. 20 and FIG. 21.

The heat exchange flow channels 12121 inside the multiple structural beams 1212 are connected in series and in parallel. This ensures that the heat exchange time can be extended under the premise of constant flow rate to achieve more sufficient heat transfer, with the characteristics of low resistance and small pressure drop, and in parallel connection, the pressure loss can be reduced, and the synchronous cooling of the parallel branches ensures consistent inlet temperature of each branch of the heat exchange flow path, which is conducive to reducing the temperature difference in different regions of the battery cell 111.

In some embodiments, referring to FIGS. 20 and FIG. 21, the first box body 121 further includes a connection pipe 1219, where one of the two outermost structural beams 1212 along the second direction Y is a first one, and the other of the two outermost structural beams 1212 along the second direction Y is a second one, and the heat exchange flow channel 12121 of the first one communicates with the heat exchange flow channel 12121 of the second one through the connection pipe 1219.

The heat exchange flow channel 12121 of the first one can communicate with the heat exchange flow channel 12121 of the second one in series through the connection pipe 1219, and the connection pipe 1219 may be provided at an end of the structural beam 1212 facing away from the current collector member 1218, which can reduce the possibility of interference after the battery cell 111 is installed.

Thus, through the arrangement of the connection pipe 1219, the multiple structural beams 1212 can achieve the layout of complex flow paths in series and parallel, which can reduce the complexity of the structure compared to the traditional complex flow paths using water cooling plates.

In some embodiments, referring to FIGS. 20 and FIG. 21, along the second direction Y, one of the structural beam 1212 between the two outermost structural beams 1212 and the connection pipe 1219 is provided with a first interface 12124, and the other of the structural beam 1212 between the two outermost structural beams 1212 and the connection pipe 1219 is provided with a second interface 12125.

One or more structural beams 1212 may be provided between the two outermost structural beams 1212. For example, when two structural beams 1212 are provided between the two outermost structural beams 1212, one of the structural beams 1212 between the two outermost structural beams 1212 and the connection pipe 1219 is provided with the second interface 12125.

Thus, the first interface 12124 and the second interface 12125 may be provided in the structural beam 1212 and the connection pipe 1219, which can achieve a variety of different heat exchange flow paths, so as to adjust according to the operating temperature of the battery apparatus 100, thereby achieving better heat exchange effect.

In some embodiments, referring to FIG. 21, the frame 1211 includes two first side beams 12111 spaced apart along the second direction Y, one of the multiple structural beams 1212 is located in the middle position of the two first side beams 12111, and the structural beam 1212 located in the middle position of the two first side beams 12111 is provided with the first interface 12124.

The middle position of the two first side beams 12111 refers to a position where the distances to the two first side beams 12111 along the second direction Y are equal.

When the battery apparatus 100 is operating, the temperature of the battery cell 111 corresponding to the structural beam 1212 in a middle region is more concentrated and higher. Through the above structure, the heat exchange medium can generally enter from the structural beam 1212 in the middle region, flow through the outermost structural beam 1212, and then flow out from the structural beam 1212 in the middle region, allowing for more uniform heat exchange, reducing the overall temperature gradient, and improving the overall heat dissipation.

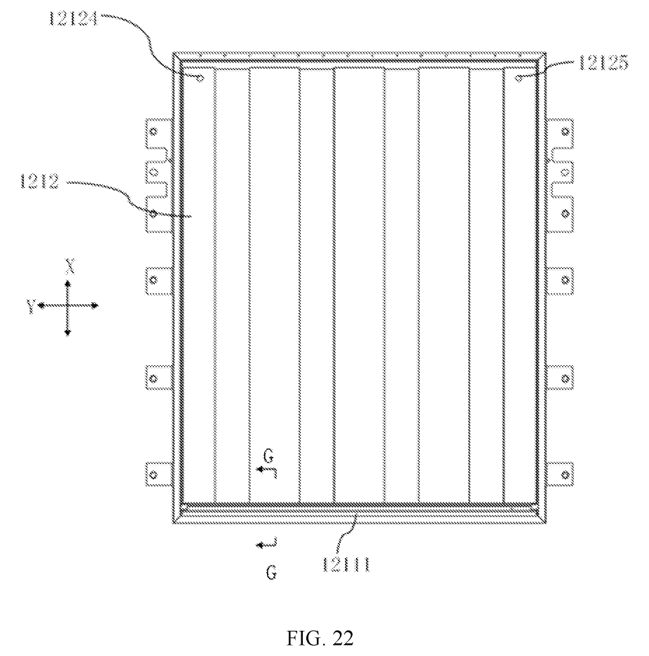

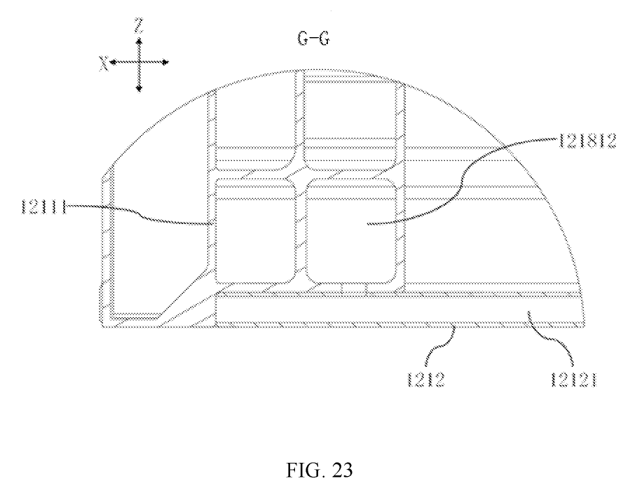

In some embodiments, referring to FIGS. 22 and FIG. 23, the frame 1211 includes two second side beams 12112 spaced apart along the first direction X, the structural beam 1212 is connected to the second side beams 12112, the second side beams 12112 are configured to connect to a vehicle, and the first direction X is configured to intersect with a traveling direction of the vehicle.

The second side beam 12112 is configured to connect to the vehicle, and the second side beam 12112 is used as a mounting beam. Since the mounting beam has the characteristics of high strength and impact resistance, the swelling force of the battery cell 111 along the first direction X can be resisted to reduce the deformation of the frame 1211. Compared to the structure where the arrangement direction of the multiple battery cells 111 in the same battery cell assembly 110 is the same as the traveling direction of the vehicle, the deformation of the frame 1211 can be reduced without increasing the weight and strength of the side beams of the frame 1211 along the first direction X, which is conducive to reducing the weight of the first box body 121.

For ease of description, an electric apparatus according to an embodiment of the present application is used as an example for description of the following embodiments.

The electric apparatus includes the battery apparatus 100 of the above embodiments, and the battery apparatus 100 is configured to provide electric energy to the electric apparatus.

The electric apparatus may be, but is not limited to, an electric bicycle, an electric tool, a vehicle 1000, a ship, and a spacecraft. For example, the spacecraft includes an airplane, a rocket, a space shuttle, and a spaceship.

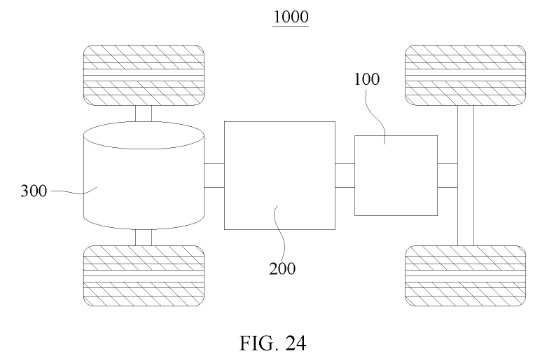

Referring to FIG. 24, which is a schematic structural diagram of a vehicle 1000 according to some embodiments of the present application. The vehicle 1000 may be a fossil fuel vehicle, a natural gas vehicle, or a new energy vehicle. The new energy vehicle may be a battery electric vehicle, a hybrid electric vehicle, a range-extended electric vehicle, or the like. The vehicle 1000 is provided with a battery apparatus 100 inside, where the battery apparatus 100 may be disposed at the bottom, front, or rear of the vehicle 1000. The battery apparatus 100 may be configured to supply power to the vehicle 1000. For example, the battery apparatus 100 may be used as an operational power source for the vehicle 1000. The vehicle 1000 may further include a controller 200 and a motor 300, where the controller 200 is configured to control the battery apparatus 100 to supply power to the motor 300, for example, to satisfy a working electricity need during start, navigation, and driving of the vehicle 1000.

Since the electric apparatus includes all the technical features of the battery apparatus 100 of the above embodiments, the effects are the same as above. Details are not described herein again.

In an optional embodiment of the battery apparatus 100, referring to FIGS. 1, FIG. 7, and FIG. 8, the battery apparatus 100 includes a battery cell assembly 110 and a box 120. The battery cell assembly 110 includes multiple battery cells 111 arranged along a first direction X. The box 120 includes a first box body 121 and a second box body 122, where the first box body 121 and the second box body 122 jointly define an accommodation space, and the battery cell assembly 110 is located in the accommodation space. The first box body 121 includes a frame 1211 and multiple structural beams 1212, the structural beams 1212 are located at the bottom of the frame 1211 and connected to the frame 1211, and the multiple structural beams 1212 are spaced apart along a second direction Y. A side of the battery cell 111 facing away from the second box body 122 has an electrode terminal 1112, the electrode terminal 1112 is located between two adjacent structural beams 1212, the battery cells 111 are respectively connected to the structural beams 1212 and the second box body 122, and the same battery cell 111 is bonded to two adjacent structural beams 1212. The first direction X intersects with the second direction Y, and a plane where the first direction X and the second direction Y are jointly located intersects with a height direction Z of the box 120. The interior of the structural beam 1212 has a heat exchange flow channel 12121, and an inlet and an outlet respectively communicating with the heat exchange flow channel 12121, where the heat exchange flow channel 12121 extends in the first direction X. The side of the battery cell 111 facing away from the second box body 122 is provided with a pressure relief mechanism 1111, where the pressure relief mechanism 1111 is configured to actuate when the battery cell 111 experiences thermal runaway and an internal pressure of the battery cell 111 reaches a set value to release emissions, and the pressure relief mechanism 1111 is provided between two adjacent structural beams 1212. The electrode terminal 1112 is spaced apart from the structural beam 1212 along the second direction Y. The electrode terminal 1112 on the side of the battery cell 111 facing away from the second box body 122 includes a positive electrode terminal and a negative electrode terminal. In two adjacent structural beams 1212, along the second direction Y, the distance from the two adjacent structural beams 1212 to the same electrode terminal 1112 is different, and the structural beam 1212 closest to the electrode terminal 1112 is a first structural beam, along the height direction Z of the box 120, a dimension of an orthographic projection of the first structural beam on the battery cell 111 in the second direction Y is S1, and the spacing between the electrode terminal 1112 and the first structural beam along the second direction Y is S2. The ratio of S1/S2 ranges from 0.65 to 87.5, and a value of S2 ranges from 8 mm to 575 mm. The frame 1211 includes first side beams 12111 spaced apart along the second direction Y and two second side beams 12112 spaced apart along the first direction X, the two outermost structural beams 1212 along the second direction Y are connected to the two first side beams 12111 in one-to-one correspondence, and the end of each structural beam 1212 is connected to the second side beam 12112. The first box body 121 includes a protective plate 1214, a buffer member 1215, and a sealing member 1216. The protective plate 1214 is located on a side of the first box body 121 facing away from the second box body 122 and is connected to the first box body 121, a gap is provided between the protective plate 1214 and the structural beam 1212, and the buffer member 1215 is provided in the gap. The sealing member 1216 is arranged around the accommodation space, and the sealing member 1216 is provided between the protective plate 1214 and the first box body 121.

Multiple structural beams 1212 are spaced apart, so that two adjacent structural beams 1212 support the same battery cell 111, the ratio of S1/S2 ranges from 0.65 to 87.5, and the value of S2 ranges from 8 mm to 575 mm. On one hand, a bonding area between the battery cell 111 and the first box body 121 can be reduced to reduce the amount of structural adhesive and reduce costs. On the other hand, the load of the structural beam 1212 can be reduced and the firmness of the battery cell 111 can be increased to improve the main frequency of the battery apparatus 100, so as to reduce the possibility of electrical connection failure of the components inside the battery apparatus 100 when there is vibration impact or when the battery cell 111 swells, thereby improving the reliability of the operation of the battery apparatus 100. The arrangement of the buffer member 1215 can further reduce the impact on the battery cell 111 in the case of impact to further improve the reliability of the operation of the battery apparatus 100.

Finally, it should be noted that the above embodiments are only used to illustrate the technical solutions of the present application, but not to limit them; although the present application has been described in detail with reference to the foregoing embodiments, those of ordinary skill in the art should understand that: they can still modify the technical solutions recorded in the foregoing embodiments, or equivalently replace some or all of the technical features therein; and these modifications or replacements do not cause the essence of the corresponding technical solutions to depart from the scope of the technical solutions of some embodiments of the present application, and they should all be covered within the scope of the claims and the specification of the present application. In particular, as long as there is no structural conflict, the technical features mentioned in the various embodiments can be combined in any way. The present application is not limited to the specific embodiments disclosed in the text, but includes all technical solutions falling within the scope of the claims.

What is claimed is:

1. A battery apparatus, comprising:
a battery cell assembly, comprising multiple battery cells arranged along a first direction; and
a box, comprising a first box body and a second box body, wherein the first box body and the second box body jointly define an accommodation space, the battery cell assembly is located in the accommodation space, the first box body comprises a frame and multiple structural beams, the structural beams are located at the bottom of the frame and connected to the frame, the multiple structural beams are spaced apart along a second direction, a side of the battery cell facing away from the second box body has an electrode terminal, the electrode terminal is located between two adjacent structural beams, the battery cells are respectively connected to the structural beams and the second box body, the first direction intersects with the second direction, and a plane where the first direction and the second direction are jointly located intersects with a height direction of the box.

2. The battery apparatus according to claim 1, wherein the battery cell is bonded to the second box body.

3. The battery apparatus according to claim 1, wherein the same battery cell is bonded to both two adjacent structural beams.

4. The battery apparatus according to claim 3, wherein the electrode terminal is spaced apart from the structural beam along the second direction.

5. The battery apparatus according to claim 4, wherein the electrode terminal on the side of the battery cell facing away from the second box body comprises a positive electrode terminal and a negative electrode terminal.

6. The battery apparatus according to claim 4, wherein:
the electrode terminal on the side of the battery cell facing away from the second box body comprises the positive electrode terminal and the negative electrode terminal, in two adjacent structural beams, along the second direction, the distance from the two adjacent structural beams to the same electrode terminal is different, and the structural beam closest to the electrode terminal is a first structural beam, along the height direction of the box, a dimension of an orthographic projection of the first structural beam on the battery cell in the second direction is S1, and the spacing between the electrode terminal and the first structural beam in the second direction is S2; and
the structural beam is a solid beam and the ratio of S1/S2 ranges from 0.25 to 87.5, or the structural beam is a hollow beam and the ratio of S1/S2 ranges from 0.65 to 87.5.

7. The battery apparatus according to claim 6, wherein:
the structural beam is a solid beam, and the ratio of S1/S2 ranges from 0.4 to 87.5; or
the structural beam is a hollow beam, and the ratio of S1/S2 ranges from 0.65 to 87.5.

8. The battery apparatus according to claim 6, wherein:
the structural beam is a solid beam, and a value of S2 ranges from 8 mm to 775 mm; or
the structural beam is a hollow beam, and a value of S2 ranges from 8 mm to 575 mm.

9. The battery apparatus according to claim 1, wherein the interior of the structural beam has a heat exchange flow channel, and an inlet and an outlet respectively communicating with the heat exchange flow channel.

10. The battery apparatus according to claim 1, wherein the side of the battery cell facing away from the second box body is provided with a pressure relief mechanism, the pressure relief mechanism is configured to actuate when the battery cell experiences thermal runaway and an internal pressure of the battery cell reaches a set value to release emissions, and the pressure relief mechanism is provided between two adjacent structural beams.

11. The battery apparatus according to claim 1, wherein the frame comprises two first side beams spaced apart along the second direction, and along the second direction, the two outermost structural beams are connected to the two first side beams in one-to-one correspondence.

12. The battery apparatus according to claim 11, wherein in the second direction, a reinforcing rib is connected between the outermost structural beam and the first side beam, and the reinforcing rib extends in the first direction.

13. The battery apparatus according to claim 1, wherein:
the first box body also comprises a spacer beam, a length direction of the spacer beam is the same as the second direction, and the battery cell assemblies are respectively provided on two sides of the spacer beam along the first direction; and
the spacer beam is connected to at least some of the structural beams, and/or the spacer beam is connected to the frame.

14. The battery apparatus according to claim 1, wherein the first box body also comprises a protective plate, and the protective plate is located on a side of the first box body facing away from the second box body and is connected to the first box body.

15. The battery apparatus according to claim 14, wherein the first box body also comprises a sealing member, the sealing member is arranged around the accommodation space, and the sealing member is sandwiched between the protective plate and the first box body.

16. The battery apparatus according to claim 1, wherein, in the height direction of the box, a gap is provided between the protective plate and the structural beam, the first box body also comprises a buffer member, and the buffer member is provided in the gap.

17. The battery apparatus according to claim 1, wherein:
the structural beam is a flat beam, a thickness direction of the structural beam is the same as the height direction of the box; and/or
the first box body is located below the second box body.

18. The battery apparatus according to claim 1, wherein the frame comprises two second side beams spaced apart along the first direction, the structural beam is connected to the second side beams, the second side beams are configured to connect to a vehicle, and the first direction is configured to intersect with a traveling direction of the vehicle.

19. An electric device, comprising the battery apparatus according to claim 1, wherein the battery apparatus is configured to provide electric energy to the electric device.
